(19) United States
(12) Patent Application Publication
(10) Pub. No.: US 2026/0203960 A1
(43) Pub. Date: Jul. 16, 2026

(54) ELECTRONIC DEVICE, METHOD, AND NON-TRANSITORY COMPUTER-READABLE STORAGE MEDIUM FOR GENERATING IMAGE USING TRAINED MODEL

(71) Applicant: SAMSUNG ELECTRONICS CO., LTD., Suwon-si (KR)

(72) Inventors: Byeongseop KIM, Suwon-si (KR); Jeongseob KIM, Suwon-si (KR); Chunbae PARK, Suwon-si (KR); Jaewoo SUH, Suwon-si (KR); Junho LEE, Suwon-si (KR); Dami JEON, Suwon-si (KR); Joonhwan JEON, Suwon-si (KR); Seunghwan CHOI, Suwon-si (KR)

(73) Assignee: SAMSUNG ELECTRONICS CO., LTD., Suwon-si (KR)

(21) Appl. No.: 19/361,861

(22) Filed: Oct. 17, 2025

Related U.S. Application Data
(63) Continuation of application No. PCT/KR2025/015142, filed on Sep. 26, 2025.

(30) Foreign Application Priority Data
Jan. 14, 2025 (KR) 10-2025-0005687
Mar. 5, 2025 (KR) 10-2025-0028526
Jul. 2, 2025 (KR) 10-2025-0088750

(51) Int. Cl. G06T 11/00; G06F 3/04842; G06F 3/04883

(52) U.S. Cl. CPC G06T 11/00; G06F 3/04842; G06F 3/04883

(57) ABSTRACT

An electronic device includes at least one processor including processing circuitry, a display, and memory including one or more storage media storing one or more programs configured to be executed by the at least one processor individually or collectively, wherein the one or more programs is configured to cause the electronic device to identify an input to obtain a second image using a first image, obtain information on the first image by providing the first image to a trained model based on the input, obtain a keyword included in the information and options with respect to the keyword, obtain the second image by providing a prompt including the information to the trained model, display, via the display, the second image and UI objects respectively indicating the options, and display, via the display, a third image based on a user input to at least one UI object from among the UI objects.

### CROSS-REFERENCE TO RELATED APPLICATIONS

This application is a by-pass continuation application of International Application No. PCT/KR2025/015142, filed on Sep. 26, 2025, which is based on and claims priority to Korean Patent Application Nos. 10-2025-0005687, filed on Jan. 14, 2025, 10-2025-0028526, filed on Mar. 5, 2025, and 10-2025-0088750, filed on Jul. 2, 2025, in the Korean Intellectual Property Office, the disclosures of which are incorporated by reference herein their entireties.

### BACKGROUND

### 1. Field

The present disclosure relates to an electronic device, a method, and a non-transitory computer-readable storage medium for generating an image using a trained model.

### 2. Description of Related Art

Artificial intelligence (AI) simulates neural activities in humans (or biological organisms), such as perception and/or inference, and may be implemented as hardware, software, or a combination of the hardware and the software, which are designed to perform computations for simulating neural activities.

The above-described information may be provided as related art for the purpose of helping the understanding of the present disclosure. No claim or determination is raised as to whether any of the above-described content may be applied as prior art related to the present disclosure.

### SUMMARY

An electronic device is described. The electronic device may comprise at least one processor comprising processing circuitry, a display, and memory comprising one or more storage media storing one or more programs configured to be executed by the at least one processor individually or collectively. The one or more programs may include instructions to cause the electronic device to identify an input to obtain a second image using a first image. The one or more programs may include instructions to cause the electronic device to provide, based on the input, the first image to a trained model. The one or more programs may include instructions to cause the electronic device to obtain information on the first image generated by the trained model using the first image. The one or more programs may include instructions to cause the electronic device to obtain a keyword included in the information and options with respect to the keyword. The one or more programs may include instructions to cause the electronic device to provide a prompt including the information to the trained model. The one or more programs may include instructions to cause the electronic device to obtain the second image, including a visual object representing the keyword, generated by the trained model using the prompt. The one or more programs may include instructions to cause the electronic device to display, via the display, the second image and user interface (UI) objects respectively indicating the options. The one or more programs may include instructions to cause the electronic device to receive, from among the UI objects, a user input to at least one UI object. The one or more programs may include instructions to cause the electronic device to display, based on the user input, via the display, a third image including another visual object representing the keyword having an option indicated by the at least one UI object.

A method is described. The method may be performed in an electronic device comprising a display. The method may comprise identifying an input to obtain a second image using a first image. The method may comprise providing, based on the input, the first image to a trained model. The method may comprise obtaining information on the first image generated by the trained model using the first image. The method may comprise obtaining a keyword included in the information and options with respect to the keyword. The method may comprise providing a prompt including the information to the trained model. The method may comprise obtaining the second image, including a visual object representing the keyword, generated by the trained model using the prompt. The method may comprise displaying, via the display, the second image and user interface (UI) objects respectively indicating the options. The method may comprise receiving, from among the UI objects, a user input to at least one UI object. The method may comprise displaying, based on the user input, via the display, a third image including another visual object representing the keyword having an option indicated by the at least one UI object.

A non-transitory computer-readable storage medium is described. The non-transitory computer-readable storage medium may store one or more programs. The one or more programs may include instructions to cause the electronic device to identify an input to obtain a second image using a first image. The one or more programs, when executed by the electronic device, may include instructions to cause the electronic device to provide, based on the input, the first image to a trained model. The one or more programs, when executed by the electronic device, may include instructions to cause the electronic device to obtain information on the first image generated by the trained model using the first image. The one or more programs, when executed by the electronic device, may include instructions to cause the electronic device to obtain a keyword included in the information and options with respect to the keyword. The one or more programs, when executed by the electronic device, may include instructions to cause the electronic device to provide a prompt including the information to the trained model. The one or more programs, when executed by the electronic device, may include instructions to cause the electronic device to obtain the second image, including a visual object representing the keyword, generated by the trained model using the prompt. The one or more programs, when executed by the electronic device, may include instructions to cause the electronic device to display, via the display, the second image and user interface (UI) objects respectively indicating the options. The one or more programs, when executed by the electronic device, may include instructions to cause the electronic device to receive, from among the UI objects, a user input to at least one UI object. The one or more programs, when executed by the electronic device, may include instructions to cause the electronic device to display, based on the user input, via the display, a third image including another visual object representing the keyword having an option indicated by the at least one UI object.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an example of an image displayed based on a handwriting input;

FIG. 2 is a block diagram of an example electronic device;

FIG. 3A is a flowchart illustrating example operations of an electronic device to obtain information on a first image;

FIG. 3B illustrates an example of a user interface (UI) for receiving an input to obtain a second image using a first image;

FIG. 4 is a flowchart illustrating example operations of an electronic device for displaying a second image and UI objects;

FIG. 5 illustrates an example of a user input for a style of a second image;

FIGS. 6A and 6B illustrate an example of a user input for displaying UI objects respectively indicating options;

FIG. 6C illustrates an example of a text input for changing portions of an object;

FIGS. 7A and 7B illustrate an example of a user input for displaying a UI object indicating an additional option;

FIG. 8 is a flowchart illustrating example operations of an electronic device for displaying a third image;

FIG. 9A illustrates an example of displaying a third image;

FIG. 9B illustrates an example of a third image obtained based on a text input;

FIGS. 10A, 10B, and 10C illustrate an example of a text input and an image input received with a handwriting input;

FIG. 10D illustrates an example of displaying a third image in another application;

FIG. 11 is a block diagram of an electronic device in a network environment according to various embodiments; and

FIG. 12 illustrates an example of a generative artificial intelligence system according to an embodiment.

### DETAILED DESCRIPTION

Hereinafter, embodiments of the present disclosure are described in detail with reference to the drawings, enabling a person of ordinary skill in the art to which the present disclosure belongs to easily implement the disclosure. However, the present disclosure may be embodied in various different forms and is not limited to the embodiments described herein. In the description of the drawings, identical or similar reference numerals may be used for identical or similar components. In addition, in the drawings and the accompanying description, descriptions of well-known functions and configurations may be omitted for clarity and conciseness.

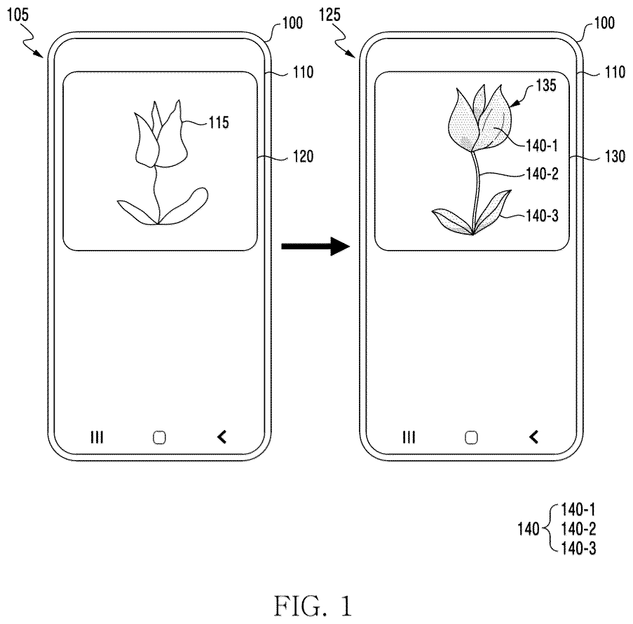

FIG. 1 illustrates an example of an image displayed based on a handwriting input.

Referring to FIG. 1, an electronic device 100 may be or correspond to a device available for receiving a handwriting input (e.g., a stroke). For example, the electronic device 100 may be one of various types of mobile devices, such as smartphones having various form factors (e.g., bar-type smartphones, foldable-type smartphones, or rollable-type smartphones), a tablet, a wearable device, a cellular phone, a personal computer (PC) (e.g., a laptop or a desktop), and/or other similar computing devices, that include circuits (or circuitry) for providing of an operation receiving a handwriting input.

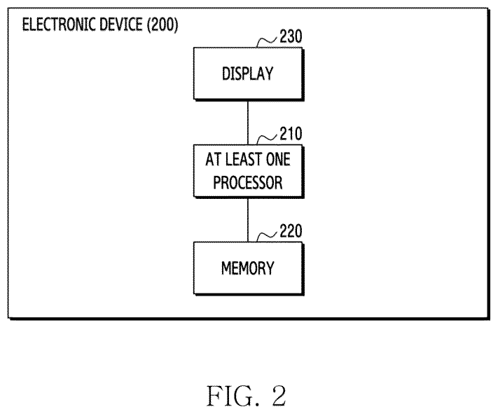

For example, the electronic device 100 may include a display 110 (e.g., a display 230 of FIG. 2). In a first state 105, the electronic device 100 may receive a handwriting input via the display 110. For example, the electronic device 100 may receive the handwriting input based on a fingertip or a pointing device in contact with the display 110, such as a stylus, a digitizer, and/or a mouse for adjusting a position of a cursor. The electronic device 100 may identify at least one stroke 115 based on the handwriting input. At least one processor 210 may display a first image 120 including the at least one stroke 115 via the display 230.

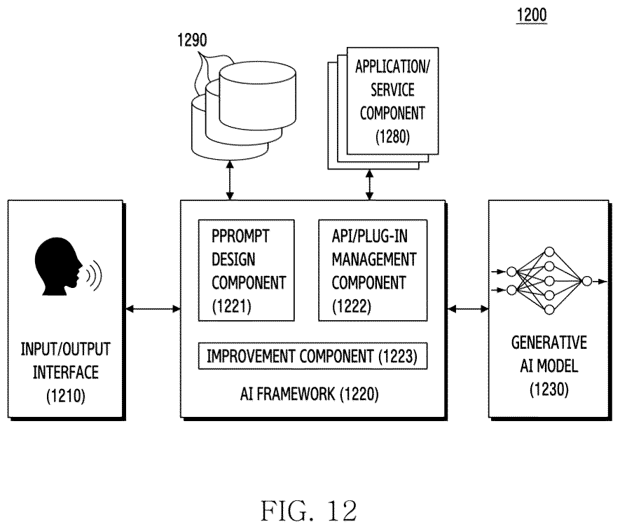

The electronic device 100 may obtain information on the first image 120 by providing the first image 120 to a trained model. For example, the trained model may include a generative artificial intelligence (AI) model 1230 of FIG. 12. For example, the at least one processor 210 may generate a prompt including the information on the first image 120. For example, the at least one processor 210 may obtain a second image 130 by providing the prompt (including the information on the first image 120) to the trained model. The prompt may include a text requesting generation of the second image 130.

The electronic device 100 may transition from the first state 105 to a second state 125 based on obtaining the second image 130. In the second state 125, the at least one processor 210 may display the second image 130 via the display 230. The second image 130 may include a visual object 135 representing or corresponding to the at least one stroke 115 included in the first image 120. The visual object 135 may include portions 140 of the visual object 135. For example, the portions 140 of the visual object 135 may be or correspond to “features” of the visual object 135. In the second image 130, the portions 140 of the visual object 135 may be represented differently from an intent of a user who provided the handwriting input. As the portions 140 of the visual object 135 are represented differently from the intent of the user in the second image 130, the user may experience inconvenience. A method may be required to resolve the inconvenience experienced by the user, caused by the portions 140 of the visual object 135 that are represented differently from the intent of the user.

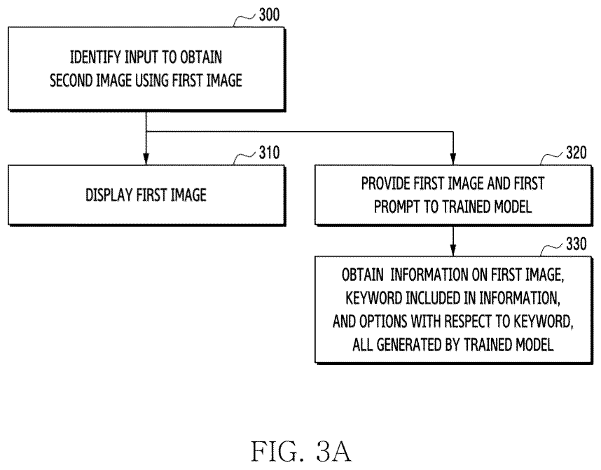

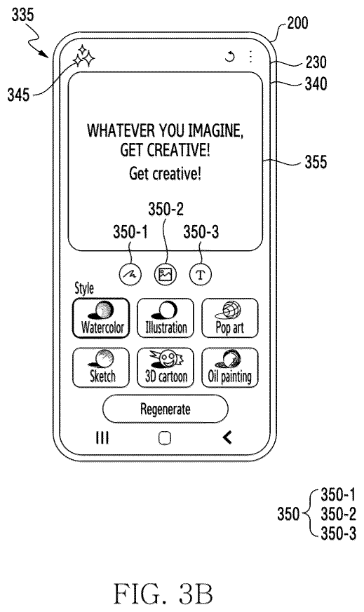

To resolve or address such inconvenience, the electronic device 100 may receive a user input for changing at least one portion among the portions 140 of the visual object 135. Based on the user input, the electronic device 100 may display, via the display 230, a third image in which at least one portion among the portions 140 of the visual object 135 is changed. The information on the first image 120 may be used to determine the portions 140 of the visual object 135 and options with respect to the portions 140 of the visual object 135. The electronic device 100 may perform operations exemplified in descriptions of FIGS. 3A to 10B to display the third image in which at least one portion among the portions 140 of the visual object 135 is changed. The electronic device 100 may include components to perform the operations. The components may be illustrated in FIG. 2.

FIG. 2 is a block diagram of an example electronic device.

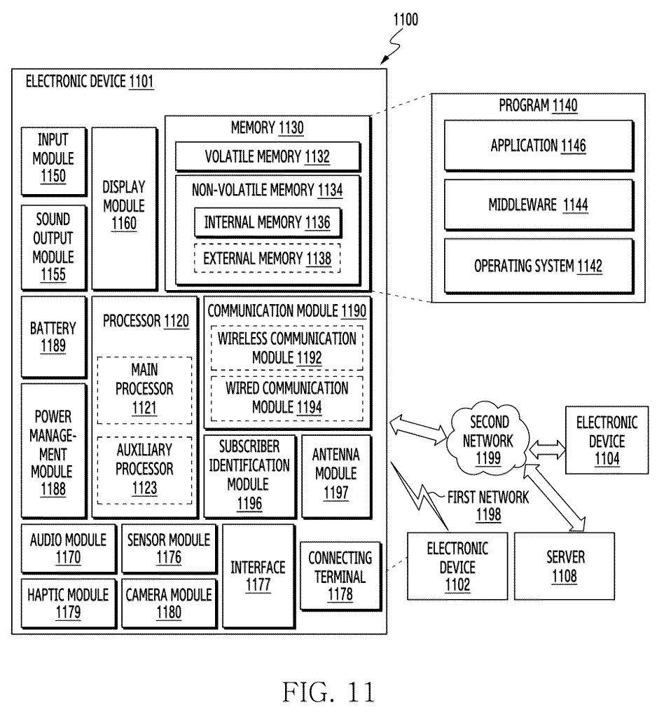

Referring to FIG. 2, an electronic device 200 may be one of various types of mobile devices, such as smartphones having various form factors (e.g., bar-type smartphones, foldable-type smartphones, or rollable-type smartphones), a tablet, a wearable device, a cellular phone, a personal computer (PC) (e.g., a laptop and/or a desktop), and/or other similar computing devices. For example, the electronic device 200 may include the electronic device 100 of FIG. 1, or may correspond to the electronic device 100 of FIG. 1. For example, the electronic device 200 may include at least a portion of an electronic device 1101 of FIG. 11, or may correspond to at least a portion of the electronic device 1101 of FIG. 11. For example, the electronic device 200 may include at least one processor 210 (e.g., a processor 1120 of FIG. 11), memory 220 (e.g., memory 1130 of FIG. 11), and the display 230 (e.g., a display module 1160 of FIG. 11).

According to an embodiment, the at least one processor 210 may include processing circuitry. For example, the at least one processor 210 may include a central processing unit (CPU) (e.g., including processing circuitry). For example, the at least one processor 210 may include a graphic processing unit (GPU) (e.g., including processing circuitry) and/or a neural processing unit (NPU) (e.g., including processing circuitry). For example, the at least one processor 210 may be or correspond to an application processor. For example, the at least one processor 210 may be configured to control the memory 220 and the display 230. The at least one processor 210 may be configured to individually or collectively execute instructions stored in the memory 220 to cause the electronic device 200 (or the electronic device 100) to perform at least a portion of the operations exemplified in the description of FIG. 1. The at least one processor 210 may be configured to execute instructions stored in the memory 220 to cause the electronic device 200 to perform at least a portion of operations exemplified in descriptions of FIGS. 3A to 10D.

According to an embodiment, the term “processor” used in the document, including the claims, may include various processing circuitry including at least one processor, and one or more of the at least one processor may be configured to perform various functions described below, individually and/or collectively, in a distributed manner. As used below, terms such as “processor,” “at least one processor,” and “one or more processors”, when described as being configured to perform various functions, encompass, for a non-limiting example, situations in which one processor performs a portion of the cited functions while another processor(s) performs another portion of the cited functions, as well as situations in which one processor is capable of performing all of the cited functions. In addition, the at least one processor may include a combination of processors that, for example, perform various enumerated/disclosed functions in a distributed manner. The at least one processor may execute program instructions to achieve or perform the various functions.

According to an embodiment, the memory 220 may include one or more storage mediums. For example, the memory 220 may store various data used by at least one component (e.g., the at least one processor 210 and/or the display 230) of the electronic device 200. For example, the data may include input data or output data for software and associated instructions. The memory 220 may include volatile memory or non-volatile memory.

According to an embodiment, the display 230 may output visualized information under the control of the at least one processor 210. For example, the display 230 may include a flat panel display (FPD) and/or electronic paper. The FPD may include a liquid crystal display (LCD), a plasma display panel (PDP), and/or one or more light emitting diodes (LEDs). For example, the LED may include an organic LED (OLED). The display 230 may include a touch sensor configured to detect touch, or a pressure sensor configured to measure intensity of force generated by the touch. For example, the display 230 may be configured to receive a handwriting input and a user input. For example, the display 230 may be configured to display an image. For example, the display 230 that supports a touch function may be referred to as a touchscreen. The display 230 may further include a structure capable of detecting an input using a stylus pen, through methods such as electro-magnetic resonance (EMR) or active electrostatic solution (AES). For example, a handwriting input may be performed using a stylus pen.

The electronic device 200 illustrated in FIG. 2 may execute at least a portion of the operations shown in FIGS. 3A to 10D. For example, the operations shown in FIGS. 3A to 10D may be caused by (or in) the electronic device 200 under the control of the at least one processor 210.

FIG. 3A is a flowchart illustrating example operations of an electronic device to obtain information on a first image.

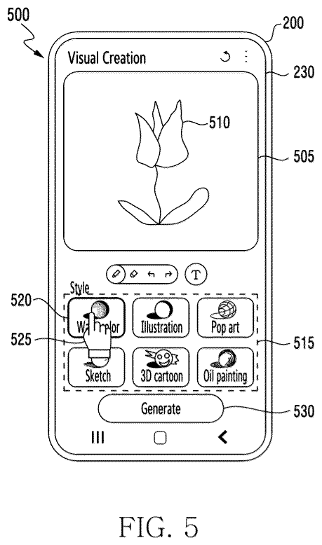

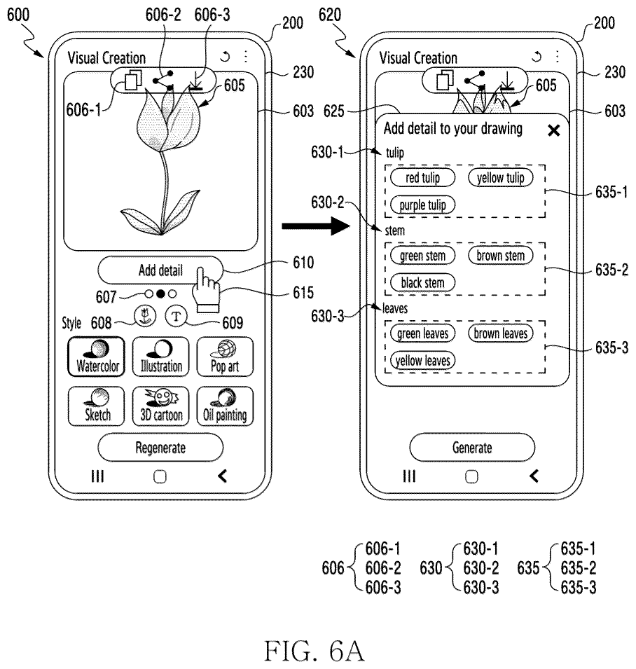

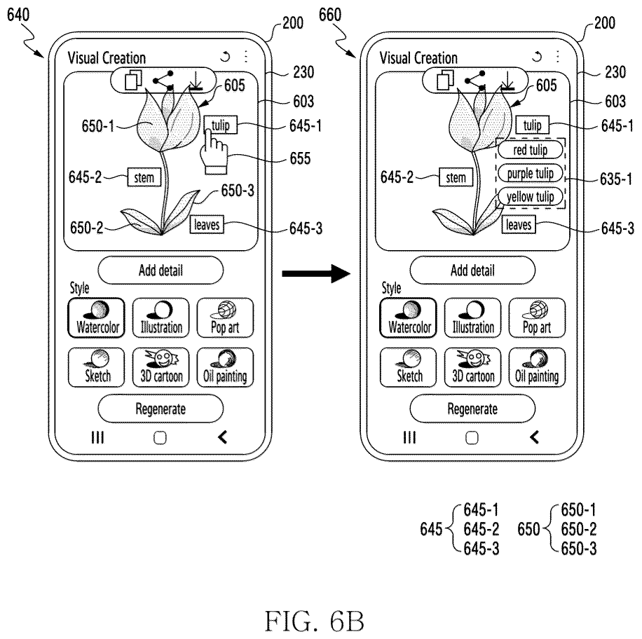

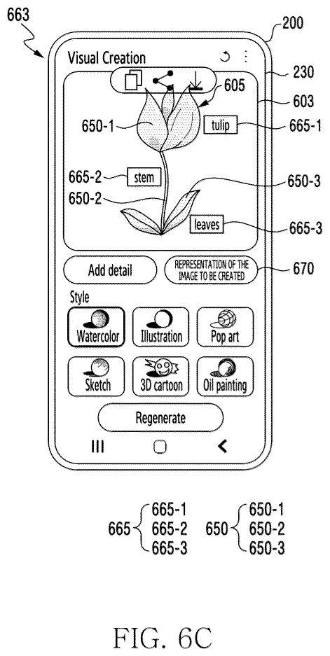

Referring to FIG. 3A, in operation 300, the at least one processor 210 may identify a input to obtain a second image (e.g., a second image 603 of FIG. 6A) using a first image (e.g., a first image 505 of FIG. 5) via a display 230. For example, the input may include a handwriting input provided by a user. For example, the handwriting input may be referred to as a drawing input. For example, the handwriting input may be received based on a fingertip or a pointing device in contact with the display 230 such as a stylus, a digitizer, and/or a mouse for adjusting a position of a cursor. For example, the handwriting input may include a user gesture of drawing a stroke using the fingertip or the pointing device. For example, the handwriting input may be received via a user interface (UI) displayed via the display 230, or may be received through an image displayed via the display 230.

The at least one processor 210 may identify at least one stroke based on the handwriting input. For example, the at least one stroke may correspond to a trajectory and/or a path dragged by a fingertip, a stylus, and/or a digitizer while the fingertip, the stylus, and/or the digitizer are in contact with the display 230. For example, the at least one stroke may correspond to a trajectory and/or a path of a cursor and/or a mouse pointer moved in the display 230 by a pointing device such as a mouse for adjusting a position of a cursor.

The at least one processor 210 may obtain a first image including the at least one stroke. For example, the at least one stroke included in the first image may include a rendered stroke. For example, by rendering the at least one stroke, the at least one processor 210 may display the at least one stroke in the first image so that it appears as if drawn using a pen.

For example, the input to obtain the second image using the first image may include an input for selecting the first image, from among images stored in an electronic device 200, as an image to be used to obtain the second image. For example, the at least one processor 210 may display the images stored in the electronic device 200 via the display 230. The at least one processor 210 may receive an input for selecting the first image from among the displayed images. For example, the input may include a touch input made on the first image. For example, the input may be received via the display 230 (e.g., a touchscreen). However, the present disclosure is not limited to the above example embodiment.

FIG. 3B illustrates an example of a user interface (UI) for receiving an input to obtain a second image using a first image.

Referring to FIG. 3B, a state 335 may be or correspond to a state in which a UI 340 for generating an image using a trained model is displayed. In the state 335, at least one processor 210 may display the UI 340 via a display 230. For example, the UI 340 may be displayed as application software for generating an image using the trained model is executed (in the foreground). For example, the UI 340 may include an indicator 345 that may indicate that the trained model is used to generate an image.

For example, the UI 340 may include UI objects 350. For example, the UI objects 350 may be used to determine an input to be received via an input field 355 in the UI 340. For example, a UI object 350-1 may indicate a handwriting input, a UI object 350-2 may indicate an image input, and a UI object 350-3 may indicate a text input.

For example, the at least one processor 210 may receive a handwriting input via the input field 355, based on a user input to the UI object 350-1. For example, based on at least one stroke identified via the handwriting input, the at least one processor 210 may obtain a first image including the at least one stroke. For example, the at least one processor 210 may receive an image input via the input field 355, based on a user input to the UI object 350-2. For example, the image input may include an input for determining a first image, from among images stored in an electronic device 200, as an image to be used to obtain a second image. For example, the at least one processor 210 may receive a text input via the input field 355, based on a user input to the UI object 350-3. For example, the text input may be received via a virtual keyboard (or soft keyboard), or may be received via a microphone of the electronic device 200. However, it is not limited thereto.

Referring again to FIG. 3A, in operation 310, the at least one processor 210 may display the first image via the display 230. For example, the first image may include at least one stroke identified in accordance with the handwriting input. For example, the at least one processor 210 may allow a user to view the at least one stroke identified in accordance with the handwriting input by displaying the first image.

For another example, the first image may include an image determined by the input from among the images stored in the electronic device 200. For example, the at least one processor 210 may allow the user to view the image determined by the input by displaying the first image.

In operation 320, the at least one processor 210 may provide the first image including the at least one stroke to the trained model. For example, the trained model may include a generative artificial intelligence (AI) model, a machine learning model, and/or a deep learning model. For example, the trained model may include a large language model (LLM). For example, the trained model may refer to a generative AI model 1230 of FIG. 12. For example, the trained model may be included in the electronic device 200, or may be included in a server (e.g., a server 1108 of FIG. 11). For example, to provide the first image to the trained model included in the server, the at least one processor 210 may transmit the first image to the server via communication circuitry. For example, the server may receive the first image from the electronic device 200. The server may provide (or input) the first image received from the electronic device 200 to the trained model.

The at least one processor 210 may provide a first prompt to the trained model with the first image. For example, the first prompt may be stored in memory 220, or may be generated by a prompt generator. For example, the prompt generator may include a prompt design component 1221 of FIG. 12. For example, the first prompt may be or correspond to a prompt to request a description of the first image. For example, the first prompt may include a text (e.g., “Describe the object”) requesting a description of the first image. For example, the first prompt may further include a text (e.g., “Extract a keyword from the object description”) requesting a keyword included in the description of the first image. For example, the keyword may be or correspond to text corresponding to a feature of an object configured with at least one stroke in the first image. For example, the first prompt may further include a text (e.g., “Tell me several changeable options for the keyword”) requesting variations (or options) with respect to the keyword included in the description of the first image. For example, the variations with respect to the keyword may include a color, a texture, a ratio, a shape, a size, and/or an appearance with respect to the feature. However, it is not limited thereto.

For example, the first prompt may further include example text (e.g., “The features of a flower include petals, a stem, and leaves.”) of the keyword included in the description of the first image. For example, the first prompt may further include example text (e.g., “Petals may be red, yellow, or blue.”) of variations (or options) with respect to the keyword. The at least one processor 210 may cause the trained model to generate the keyword included in the description of the first image and/or variations with respect to the keyword in accordance with the example texts, by providing the trained model with the first prompt including the example text of the keyword included in the description of the first image and/or the example text of variations with respect to the keyword.

In operation 330, the at least one processor 210 may obtain information on the first image generated by the trained model using the first image. For example, when the trained model is included in the server, the server may transmit the information on the first image generated by the trained model using the first image to the electronic device 200. The at least one processor 210 may obtain the information on the first image by receiving the information on the first image from the server via the communication circuitry. For example, the information on the first image may include a text describing the first image (e.g., “A simple line drawing of a tulip. The tulip has one stem with two leaves. The stem is connected to the base.”).

For example, the at least one processor 210 may obtain a keyword (e.g., “tulip,” “stem,” and/or “leaf”) included in the information. For example, the keyword included in the information may refer to features of an object described by the information. For example, the features of an object described by the information may be or correspond to changeable portions of an object described by the information. For example, the at least one processor 210 may obtain options (or variations) with respect to the keywords (e.g., “Tulip: red, yellow, purple,” “Stem: green, brown, black,” and/or “Leaf: green, brown, yellow”). For example, options (or variations) with respect to the keywords may include changeable (or addable) texts with respect to the keywords. For example, options with respect to the keywords may be or correspond to options (or variations) of changeable portions of an object. For example, a trained model may be utilized to obtain keywords included in the information and options (or variations) with respect to the keywords. For example, the at least one processor 210 may provide the information on the first image to the trained model again. For example, the at least one processor 210 may obtain keywords included in the information and options with respect to the keywords generated by the trained model using the information on the first image.

According to another embodiment, when the first prompt provided to the trained model includes text requesting a description of the first image, text requesting keywords included in the description of the first image, and text requesting variations with respect to the keywords, the at least one processor 210 may obtain the information on the first image with a keyword included in the information and options with respect to the keywords, all generated by the trained model.

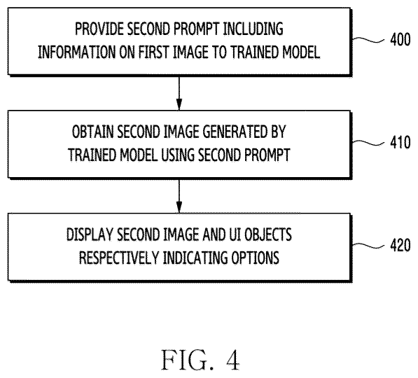

For example, the operation 320 and the operation 330 may be performed after the operation 310 is performed. For example, the operation 320 and the operation 330 may be performed while the first image is displayed. For example, the operation 320 and the operation 330 may be performed while the operation 310 is performed, or may be performed before the operation 310 is performed. However, it is not limited thereto. For example, the at least one processor 210 may obtain the second image using the information on the first image. Obtaining the second image using the information on the first image is exemplified in a description of FIG. 4.

FIG. 4 is a flowchart illustrating example operations of an electronic device for displaying a second image and user interface (UI) objects.

Referring to FIG. 4, in operation 400, at least one processor 210 may provide a second prompt, which includes information on a first image, to a trained model. For example, the trained model may include a model for generating an image (e.g., a diffusion model). For example, the trained model may correspond to a trained model used to generate information on the first image, or may differ from the trained model used to generate information on the first image. For example, the trained model may be included in an electronic device 200, or may be included in a server. For example, when the trained model is included in the server, the at least one processor 210 may provide the second prompt to the trained model by transmitting the second prompt to the server using communication circuitry.

For example, the second prompt may be stored in memory 220 or generated by a prompt generator. The prompt generator may include a prompt design component 1221 of FIG. 12. For example, the second prompt may include a text (e.g., “A simple line drawing of a tulip. The tulip has one stem with two leaves. The stem is connected to the base. Please draw an image of this”) requesting generation of an image in accordance with the information on the first image.

In operation 410, the at least one processor 210 may obtain a second image generated by the trained model using the second prompt. For example, the second image may be derived from the second prompt, which includes the information on the first image. For example, the second image may include an object representing the information on the first image. For example, the object representing the information on the first image may include portions of the object that respectively represent keywords included in the information on the first image. For example, the portions of the object that respectively represent the keywords included in the information on the first image may be referred to as features of the object.

For example, a style of the second image may be determined based on a user input for the style of the second image. The at least one processor 210 may receive the user input for the style of the second image before obtaining the second image. The user input for the style of the second image is exemplified in a description of FIG. 5.

FIG. 5 illustrates an example of a user input for a style of a second image.

Referring to FIG. 5, a state 500 may be or correspond to a state in which a UI for handwriting input is displayed. In the state 500, at least one processor 210 may display, via a display 230, UI objects 515 for determining (or identifying) a style of a second image to be generated using a trained model, in the UI for handwriting input. For example, the UI objects 515 may include a UI object for a style corresponding to watercolor, a UI object for a style corresponding to illustration, a UI object for a style corresponding to pop art, a UI object for a style corresponding to a sketch, a UI object for a style corresponding to a three-dimensional (3D) cartoon, and a UI object for a style corresponding to oil painting. For example, when an image input is received, the at least one processor 210 may identify whether an image identified in accordance with the image input includes a human face. Based on identifying that the image identified in accordance with the image input includes a human face, the at least one processor 210 may further display a UI object for a style corresponding to comic, a UI object for a style corresponding to a 3D character, a UI object for a style corresponding to a sketch, and a UI object for a style corresponding to watercolor. However, it is not limited to thereto. The at least one processor 210 may receive a user input 525 to one UI object 520 from among the UI objects. For example, the user input 525 may be or correspond to a user input for the style of the second image. For example, the user input 525 may include a touch input having a contact point on the UI object 520. The user input 525 may be received via the display 230 (e.g., a touchscreen). For example, the user input 525 may be received via an external electronic device (e.g., a mouse) connected to an electronic device 200. For example, the user input 525 may include a voice (or a speech) input received via a microphone (e.g., an audio module 1170 of FIG. 11) of the electronic device 200. However, it is not limited thereto.

For example, the user input 525 may be received either before a handwriting input is received or after a handwriting input is received. The at least one processor 210 may receive a handwriting input after receiving the user input 525, or may receive the user input 525 after receiving a handwriting input. Based on the handwriting input, the at least one processor 210 may display, via the display 230, a first image 505 including at least one stroke 510 identified in accordance with the handwriting input. Based on the user input 525, the at least one processor 210 may change an appearance (e.g., color) of the UI object 520 to which the user input 525 is received. The at least one processor 210 may indicate that an input to the UI object 520 is received by displaying the UI object 520 with the changed appearance (e.g., color).

For example, the at least one processor 210 may display, via the display 230, a UI object 530 for generating an image in the UI for handwriting input. The at least one processor 210 may receive a user input to the UI object 530. The user input to the UI object 530 may be received after the handwriting input and the user input 525 are received. Based on the user input to the UI object 530, the at least one processor 210 may obtain information on the first image, a keyword included in the information, and options with respect to the keyword by providing the first image 505 and a first prompt to the trained model. For example, obtaining information on the first image, a keyword included in the information, and options with respect to the keyword may refer to the operation 320 to the operation 330 of FIG. 3A. The at least one processor 210 may obtain the second image by providing a second prompt including the information on the first image to the trained model. For example, the second prompt may further include other information on a style (e.g., a style corresponding to watercolor) indicated by the UI object 530 to which the user input 525 is received. For example, the second image may be derived from the second prompt. For example, the second image may have a style (e.g., a style corresponding to watercolor) indicated by the UI object 530.

Referring again to FIG. 4, in operation 420, the at least one processor 210 may display the second image via the display 230. For example, portions of an object included in the second image may be represented differently from an intent of a user. For example, changing portions of the object included in the second image, which are represented differently from the intent of the user, may be required based on a user input.

The at least one processor 210 may display, via the display 230, information on a keyword included in the information on the first image. For example, since the keyword is represented by a portion of the object in the second image, the at least one processor 210 may indicate a changeable portion of the object in the second image by displaying the keyword. The at least one processor 210 may display, via the display 230, UI objects respectively indicating options with respect to the keyword as associated with the keyword. For example, the UI objects may indicate options for a portion of the object in the second image that represents the keyword. For example, the UI objects may be displayed based on a user input. The user input for displaying the UI objects is exemplified in descriptions of FIGS. 6A and 6B.

FIGS. 6A and 6B illustrate an example of a user input for displaying UI objects respectively indicating options.

Referring to FIG. 6A, a state 600 may be or correspond to a state in which a second image 603 is displayed. In the state 600, at least one processor 210 may display, via a display 230, UI objects 606 with the second image 603. The at least one processor 210 may receive a user input to the UI objects 606. The user input to the UI objects 606 may include a touch input having a contact point on the UI objects 606. For example, the user input to the UI objects 606 may be received via the display 230 (e.g., a touchscreen).

For example, based on a user input to a UI object 606-1, the at least one processor 210 may store (or clip) the second image 603 to a clipboard. For example, the user input to the UI object 606-1 may be or correspond to a user input for copying the second image 603. For example, based on a user input to a UI object 606-2, the at least one processor 210 may share (or transmit) the second image 603. After receiving the user input to the UI object 606-2, the at least one processor 210 may receive a user input for determining an external electronic device (or user, or user identifier (ID)) to which the second image 603 is to be shared (or transmitted). For example, the at least one processor 210 may share (or transmit) the second image 603 to the determined external electronic device (or user, or user ID). Based on a user input to a UI object 606-3, the at least one processor 210 may store the second image 603 in an electronic device 200 (or in memory 220). For another example, based on the user input to the UI object 606-3, the at least one processor 210 may store an object 605 in the electronic device 200 by cropping the object 605 in the second image 603. For example, the object 605 may be stored as a sticker in the electronic device 200, and the object 605 stored as the sticker may be added onto another image or transmitted to an external electronic device via a messenger application.

For example, the at least one processor 210 may further display, via the display 230 an indicator 607 with the second image 603. For example, the indicator 607 may indicate that a scroll input (e.g., a horizontal scroll input) may be received via the second image 603. Based on the scroll input received on the second image 603, the at least one processor 210 may display a first image (e.g., the first image 505 of FIG. 5) or other images generated using the first image. For example, the indicator 607 may represent an image being displayed via the display 230, from among the second image 603, the first image, and the other images.

For example, the at least one processor 210 may further display, via the display 230 a UI object 608 and a UI object 609 with the second image 603. For example, the at least one processor 210 may receive a user input to the UI object 608 and the UI object 609. For example, the UI object 608 may represent the first image. For example, based on the user input to the UI object 608, the at least one processor 210 may modify (or change) the first image. For example, based on the user input to the UI object 609, the at least one processor 210 may receive a text input. The at least one processor 210 may generate a prompt using a text identified via the text input. The at least one processor 210 may obtain another image generated by a trained model using the second image 603 and the prompt by providing the second image 603 and the prompt to the trained model.

The at least one processor 210 may display, via the display 230, a UI object 610 for changing (or modifying) the second image 603. The at least one processor 210 may receive a user input 615 to the UI object 610. For example, the user input 615 may include a touch input having a contact point on the UI object 610. The user input 615 may be received via the display 230 (e.g., a touchscreen). For example, the user input 615 may be received via an external electronic device (e.g., a mouse) connected to the electronic device 200. For example, the user input 615 may include a voice (or speech) input received via a microphone of the electronic device 200. However, it is not limited thereto.

The electronic device 200 may transition from the state 600 to a state 620 based on the user input 615. In the state 620, the at least one processor 210 may display a window 625 based on the user input 615. For example, the window 625 may include information 630 on keywords included in information on the first image. For example, the information 630 on the keywords may include a text (e.g., “tulip”, “stem”, and/or “leaves”) indicating the keywords. The keywords may respectively represent portions of the object 605 in the second image 603. The at least one processor 210 may indicate changeable portions of the object 605 in the second image 603 by displaying the information 630 on the keywords.

For example, the window 625 may further include UI objects 635 respectively indicating options with respect to the keywords. The at least one processor 210 may display the UI objects 635 respectively indicating the options, as associated with the information 630 on the keywords, in the window 625. For example, the UI objects 635 respectively indicating the options may include a text (e.g., “red tulip”, “yellow tulip”, and/or “purple tulip”) respectively indicating the options. For example, as the at least one processor 210 displays UI objects 635-1 as associated with information 630-1 on a keyword, it may indicate options with respect to a portion of the object 605 in the second image 603 that represents the keyword.

Referring to FIG. 6B, a state 640 may be or correspond to a state in which the second image 603 is displayed. In the state 640, the at least one processor 210 may display, via the display 230, UI objects 645 respectively indicating keywords on the second image 603. For example, the UI objects 645 may include a text (e.g., “tulip”, “stem”, and/or “leaves”) indicating a keyword. The UI objects 645 may be displayed as associated with portions 650 of the object 605 in the second image 603 that represent the keywords. For example, a UI object 645-1 may be displayed as associated with a portion 650-1 of the object 605 that represents a keyword indicated by the UI object 645-1. For example, a UI object 645-2 may be displayed as associated with a portion 650-2 of the object 605 that represents a keyword indicated by the UI object 645-2. For example, a UI object 645-3 may be displayed as associated with a portion 650-3 of the object 605 that represents a keyword indicated by the UI object 645-3. The at least one processor 210 may intuitively indicate changeable portions of the object 605 by displaying the UI objects 645 as associated with the portions 650 of the object 605 that represent the keywords.

The at least one processor 210 may receive a user input 655 to the UI objects 645. For example, the user input 655 to the UI objects 645 may be or correspond to a user input for changing portions of the object 605 that represent the keywords indicated by the UI objects 645. For example, the user input 655 may include a touch input having a contact point on the UI objects 645. The user input 655 may be received via the display 230 (e.g., a touchscreen). For example, the user input 655 may be received via an external electronic device (e.g., a mouse) connected to the electronic device 200. For example, the user input 655 may include a voice (or speech) input received via a microphone of the electronic device 200. However, it is not limited thereto.

The electronic device 200 may transition from the state 640 to a state 660 (shown in FIG. 6B) based on the user input 655 to the UI object 645-1. In the state 660, based on the user input 655, the at least one processor 210 may display the UI objects 635-1 indicating options, as associated with the UI object 645-1 for which the user input 655 is received. The options respectively indicated by the UI objects 635-1 may be or correspond to options with respect to the keyword indicated by the UI object 645-1. For example, the UI objects 635-1 respectively indicating the options may include a text (e.g., “red tulip”, “yellow tulip”, and/or “purple tulip”) respectively indicating the options. As the UI objects 635-1 are displayed as associated with the object 645-1 indicating a keyword, the options with respect to a portion of the object 605 in the second image 603 that represents the keyword may be indicated.

For example, the options indicated by the executable objects 635-1 may not include an option intended by a user. For example, the at least one processor 210 may receive a text input indicating the option intended by the user, in order to change the portions 650 of the object 605. The text input indicating the option intended by the user is described with reference to FIG. 6C.

FIG. 6C illustrates an example of a text input for changing portions of an object.

Referring to FIG. 6C, a state 663 may be or correspond to a state in which the second image 603 is displayed. In the state 663, the at least one processor 210 may display, via the display 230, information 665 indicating the keywords on the second image 603. For example, the information 665 may include a text (e.g., “tulip”, “stem”, and/or “leaves”) indicating a keyword. For example, the information 665 may be displayed as associated with the portions 650 of the object 605 in the second image 603 that represent the keywords. For example, first information 665-1 may be displayed as associated with the portion 650-1 of the object 605 that represents a keyword indicated by the first information 665-1. For example, second information 665-2 may be displayed as associated with the portion 650-2 of the object 605 that represents a keyword indicated by the second information 665-2. For example, third information 665-3 may be displayed as associated with the portion 650-3 of the object 605 that represents a keyword indicated by the third information 665-3. The at least one processor 210 may intuitively indicate changeable portions of the object 605 by displaying the information 665 as associated with the portions 650 of the object 605 that represent the keywords.

For example, the at least one processor 210 may display a text input field 670 via the display 230. For example, the text input field 670 may be displayed simultaneously with the second image 603. For example, the at least one processor 210 may receive a text input via the text input field 670. For example, the text input may be or correspond to an input for changing the portions 650 of the object 605 that represent the keywords indicated by the information 665.

For example, the text input may be received via a virtual keyboard. For example, the virtual keyboard may be displayed via the display 230 based on a touch input having a contact point on the text input field 670. For example, the text input may be received via an external electronic device (e.g., a keyboard) connected to the electronic device 200. For example, the text input may include a voice input (or speech input) received via a microphone of the electronic device 200. However, it is not limited thereto.

For example, a text corresponding to the text input may include the keywords (e.g., “tulip”, “stem”, and “leaves”) indicated by the information 665. For example, the text corresponding to the text input may include a text indicating a change of the portions 650 of the object 605 in the second image 603. For example, the text corresponding to the text input may include additional keywords not included in the information 665. For example, the text corresponding to the text input may include a text indicating a change of portions of the object 605 in the second image 603 that are represented by the additional keywords.

For example, the text corresponding to the text input may include a text indicating deletion (or removal) of the portions 650 of the object 605 in the second image 603. For example, the text corresponding to the text input may include a text indicating addition of another object in the second image 603. For example, the at least one processor 210 may generate a prompt for changing the second image 603 using the text received via the text input field 670.

For example, the at least one processor 210 may change the portions 650 of the object 605 in the second image 603 in detail using the text received via the text input field 670. For example, the at least one processor 210 may change (or delete, or add) the portions 650 of the object 605 and other portions of the object 605 in the second image 603, using the text received via the text input field 670.

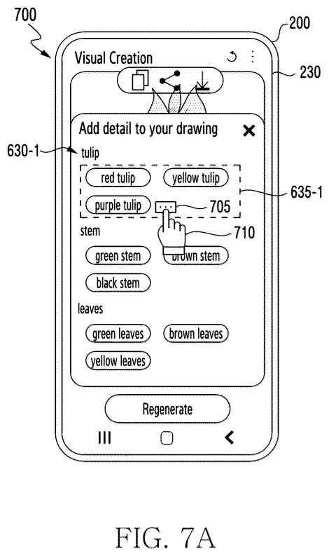

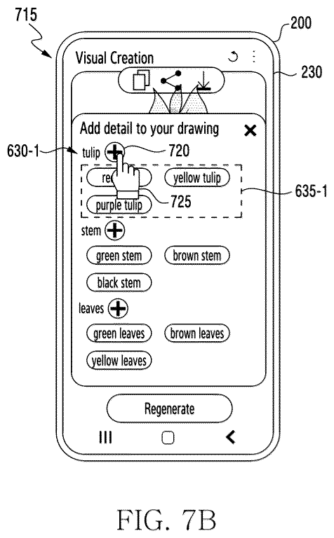

For example, the option intended by the user may not be included in the options indicated by the UI objects 635-1 in FIG. 6A and FIG. 6B. For example, displaying a UI object indicating an additional option may be required. Displaying the UI object indicating the additional option is exemplified in descriptions of FIG. 7A and FIG. 7B.

FIGS. 7A and 7B illustrate an example of a user input for displaying a UI object indicating an additional option.

Referring to FIG. 7A, a state 700 may be or correspond to a state in which UI objects 635-1, respectively indicating fewer options than the obtained options, are displayed. In the state 700, at least one processor 210 may display, via a display 230, a reference number of the UI objects 635-1. For example, the reference number may be or correspond to the number of the UI objects 635-1 that may be displayed as associated with information 630-1 on a keyword. The reference number may be predetermined or configured (or changed) by a user. For example, when the UI objects 635-1 exceeding the reference number are displayed, an area occupied by the UI objects 635-1 in a UI may become excessively wide, or an area to display UI objects indicating options with respect to another keyword may become insufficient. Even when the number of options with respect to a keyword included in information on a first image exceeds the reference number, the at least one processor 210 may display the reference number of the UI objects 635-1, as associated with the information 630-1 on the keyword.

For example, an option intended by the user may not be included among the options indicated by the reference number of the UI objects 635-1. The at least one processor 210 may display, via the display 230, a UI object 705 for an additional option, as associated with the UI objects 635-1 (or the information 630-1 on the keyword). The at least one processor 210 may receive a user input 710 to the UI object 705. For example, the user input 710 may include a touch input having a contact point on the UI object 705. The user input 710 may be received via the display 230 (e.g., a touchscreen). For example, the user input 710 may be received via an external electronic device (e.g., a mouse) connected to an electronic device 200. For example, the user input 710 may include a voice (or speech) input received via a microphone of the electronic device 200. However, it's not limited thereto.

Based on the user input 710 to the UI object 705, the at least one processor 210 may further display, via the display 230, a UI object indicating an additional option, or display the UI object indicating an additional option in replacement of the UI objects 635-1. However, it is not limited thereto. The at least one processor 210 may provide the user with a changeable additional option for a portion of an object representing the keyword, by displaying the UI object indicating the additional option.

Referring to FIG. 7B, in a state 715, the at least one processor 210 may display, via the display 230, the information 630-1 on the keyword, and UI objects 635-1 respectively indicating the options. The UI objects 635-1 may be displayed as associated with the information 630-1 on the keyword. For example, an option intended by the user may not be included among the options indicated by the UI objects 635-1. The at least one processor 210 may further display, via the display 230, a UI object 720 for an additional option, as associated with the information 630-1 on the keyword (or the UI objects 635-1).

The at least one processor 210 may receive a user input 725 to the UI object 720. For example, the user input 725 may include a touch input having a contact point on the UI object 720. The user input 725 may be received via the display 230 (e.g., a touchscreen). For example, the user input 725 may be received via an external electronic device (e.g., a mouse) connected to the electronic device 200. For example, the user input 725 may include a voice (or speech) input received via a microphone of the electronic device 200. However, it is not limited thereto.

Based on the user input 725 to the UI object 720, the at least one processor 210 may display an input field for an additional option via the display 230. The at least one processor 210 may receive a user input for the additional option via the input field. For example, the user input for the additional option may include a text input and/or a voice (or speech) input. For example, the user input for the additional option may be received via a virtual keyboard, or via a microphone of the electronic device 200. However, it is not limited thereto.

Based on the user input for the additional option, the at least one processor 210 may further display a UI object indicating the additional option, or display the UI object indicating the additional option in replacement of the UI objects 635-1, via the display 230. However, it is not limited thereto. For example, the additional option may be determined by a text (or a voice) identified in accordance with the user input. The at least one processor 210 may provide the user with a changeable additional option for a portion of an object representing the keyword, by displaying the UI object indicating the additional option.

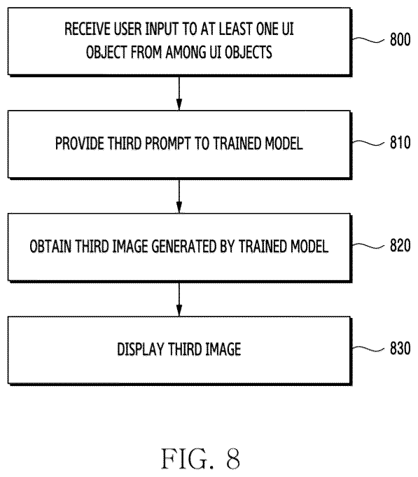

The at least one processor 210 may receive a user input to one UI object from among the UI objects 635-1 indicating options. The at least one processor 210 may display a third image based on the user input to the UI object. Displaying the third image based on the user input to the UI object is exemplified in a description of FIG. 8.

FIG. 8 is a flowchart illustrating example operations of an electronic device for displaying a third image.

Referring to FIG. 8, in operation 800, at least one processor 210 may receive a user input to at least one UI object from among UI objects respectively indicating options. For example, the user input to the at least one UI object may include a touch input having a contact point on the at least one UI object. The user input to the at least one UI object may be received via the display 230 (e.g., a touchscreen). For example, the user input to the at least one UI object may be received via an external electronic device (e.g., a mouse) connected to an electronic device 200. For example, the user input to the at least one UI object may include a voice (or speech) input received via a microphone of the electronic device 200. However, it is not limited thereto.

According to another embodiment, the at least one processor 210 may bypass (or refrain from, or skip, or cease, or not generate) generating a second image, and may display UI objects via the display 230. For example, the at least one processor 210 may bypass (or refrain from, or skip, or cease, or not display) displaying the second image, and may display a third image based on a user input to one UI object from among the UI objects.

In operation 810, based on the user input to the at least one UI object, the at least one processor 210 may provide a third prompt, which includes information on a first image and information on an option indicated by the at least one UI object, to a trained model. For example, the trained model may include a model for generating an image (e.g., a diffusion model). For example, the trained model may be used to generate information on the first image, or may differ from the trained model used to generate information on the first image. For example, the trained model may be included in the electronic device 200, or may be included in a server. For example, the at least one processor 210 may provide the third prompt to the trained model by transmitting the third prompt to the server using communication circuitry.

For example, the third prompt may be generated by a prompt generator that may include a prompt design component 1221 of FIG. 12. For example, the third prompt may include the option indicated by the at least one UI object, and may include a text (e.g., “A simple line drawing of a tulip. A purple tulip has one stem with two leaves. The stem is connected to the base. Please draw an image of this.”) requesting generation of an image in accordance with the information on the first image. For example, the third prompt may be or correspond to a prompt further including information on the option indicated by the at least one UI object in a second prompt. For example, the third prompt may further include a text corresponding to a text input via the text input field 670 of FIG. 6C.

According to another embodiment, the at least one processor 210 may provide the first image to the trained model with the third prompt. For example, a third image generated by the trained model using the third prompt may include a visual object having a different shape from a visual object included in the second image. For example, it may be required to obtain a third image that includes an object having a shape corresponding to the shape of the visual object included in the second image. The shape represents a keyword having the option indicated by the at least one UI object. For example, the at least one processor 210 may perform control scaling by further providing the first image to the trained model. By performing the control scaling, the at least one processor 210 may apply a weight to the first image. By applying a weight to the first image, the at least one processor 210 may cause the trained model to generate a third image that includes a visual object having a shape corresponding to the shape of the visual object included in the second image in accordance with the weight.

In operation 820, the at least one processor 210 may obtain the third image generated by the trained model using the third prompt. For example, the third image may be derived from the third prompt that includes the information on the first image and the information on the option indicated by the at least one UI object. For example, the third image may include an object representing the information on the first image. For example, the object representing the information on the first image may include portions of the object that respectively represent keywords included in the information on the first image. For example, a portion of the object representing the information on the first image may represent a keyword having the option indicated by the at least one UI object.

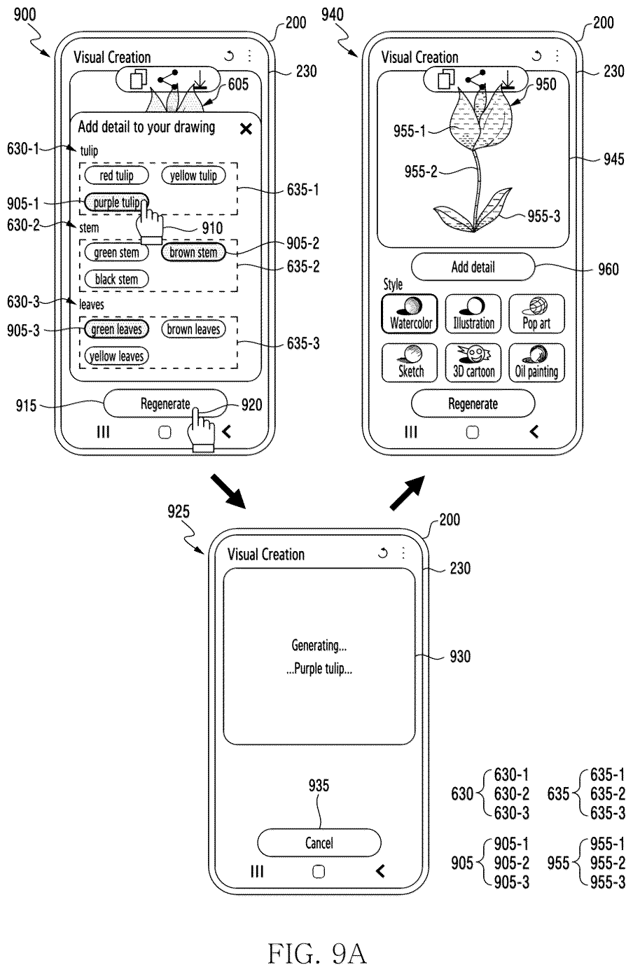

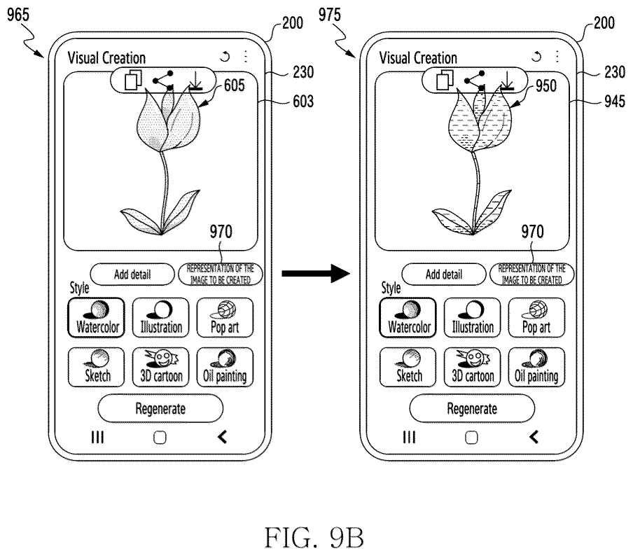

In operation 830, the at least one processor 210 may display the third image via the display 230. For example, the object included in the third image may include a portion of the object representing a keyword having the option indicated by the at least one UI object. For example, the object included in the third image may include a representation intended by a user. The at least one processor 210 may provide the object that includes a representation intended by the user by displaying the third image. Displaying the third image is exemplified in a description of FIG. 9A.

FIG. 9A illustrates an example of displaying a third image.

Referring to FIG. 9A, a state 900 may be or correspond to a state in which UI objects 635 respectively indicating options are displayed. In the state 900, at least one processor 210 may display, via a display 230, the UI objects 635 as associated with information 630 on keywords. The at least one processor 210 may receive a user input 910 to one UI object 905-1 from among UI objects 635-1 displayed as associated with information 630-1 on the keywords. For example, the user input 910 may include a touch input having a contact point on the UI object 905-1. The user input 910 may be received via the display 230 (e.g., a touchscreen). For example, the user input 910 may be received via an external electronic device (e.g., a mouse) connected to an electronic device 200. For example, the user input 910 may include a voice (or speech) input received via a microphone of the electronic device 200. However, it is not limited thereto.

For example, the at least one processor 210 may further receive a user input to one UI object 905-2 from among UI objects 635-2 displayed as associated with information 630-2 on a keyword and/or a user input to one UI object 905-3 from among UI objects 635-3 displayed as associated with information 630-3 on a keyword. For example, based on the user input 910 (or the user input to the UI object 905-2, or the user input to the UI object 905-3), the at least one processor 210 may change an appearance (e.g., color) of the UI object 905-1 (or the UI object 905-2, or the UI object 905-3) to which the user input 910 is received. The at least one processor 210 may indicate that an input to a UI object 905-1 (or the UI object 905-2, or the UI object 905-3) is received by displaying the UI object 905-1 (or the UI object 905-2, or the UI object 905-3) with the changed appearance (e.g., color).

For example, the at least one processor 210 may display a UI object 915 for generating (or regenerating) an image via the display 230. For example, the at least one processor 210 may receive a user input 920 to the UI object 915. For example, the user input 920 to the UI object 915 may be received after the user input 910, the user input to the UI object 905-2, and/or the user input to the UI object 905-3 is received. For example, the user input 920 may include a touch input having a contact point on the UI object 915. The user input 920 may be received via the display 230 (e.g., a touchscreen). For example, the user input 920 may be received via an external electronic device (e.g., a mouse) connected to the electronic device 200. For example, the user input 920 may include a voice (or speech) input received via a microphone of the electronic device 200. However, it is not limited thereto.

The electronic device 200 may transition from the state 900 to a state 925 based on the user input 920. In the state 925, based on the user input 920, the at least one processor 210 may display, via the display 230, information 930 indicating that a third image 945 is generated. For example, the information 930 may include a text (e.g., “generating”) indicating that the third image 945 is generated. For example, the information 930 may include a text (e.g., “purple tulip”) for an option indicated by the UI object 905-1, to which the user input 910 is received. However, it is not limited thereto.

Based on the user input 920, the at least one processor 210 may provide a third prompt, which includes information on a first image and information on an option indicated by a UI object, to a trained model. The at least one processor 210 may obtain a third image generated by the trained model using the third prompt. For example, obtaining the third image 945 may refer to the descriptions of the operation 810 and the operation 820 of FIG. 8.

For example, the at least one processor 210 may display a UI object 935 via the display 230 to cease the generation of the third image. The at least one processor 210 may receive a user input to the UI object 935. The at least one processor 210 may cease (or refrain from, or skip, or bypass, or not generate) generating the third image, based on the user input to the UI object 935.

For example, the information 930 indicating that the third image 945 is generated may be displayed until the third image 945 is obtained. The electronic device 200 may transition from the state 925 to a state 940 based on obtaining the third image 945. In the state 940, the at least one processor 210 may display the third image 945 via the display 230, based on obtaining the third image 945. An object 950 in the third image 945 may represent keywords having options indicated by the UI objects 905 to which the user inputs are received. For example, the object 950 may include a portion 955-1 of the object 950 representing a keyword having an option (e.g., “purple tulip”) indicated by the UI object 905-1. For example, the object 950 may include a portion 955-2 of the object 950 representing a keyword having an option (e.g., “brown stem”) indicated by the UI object 905-2. For example, the object 950 may include a portion 955-3 of the object 950 representing a keyword having an option (e.g., “green leaves”) indicated by the UI object 905-3. For example, the portions 955 of the object 950 may correspond to representations intended by a user. For example, the at least one processor 210 may provide the object 950 including representations intended by the user by displaying the third image 945.

For example, the at least one processor 210 may display, via the display 230, a UI object 960 for changing (or modifying) the third image 945. For example, the UI object 960 may refer to the UI object 610 of FIG. 6A. The at least one processor 210 may receive a user input to the UI object 960. The at least one processor 210 may display a window (e.g., the window 625 of FIG. 6A), based on a user input 615. For example, the at least one processor 210 may additionally change (or modify) the third image 945 via the window.

FIG. 9B illustrates an example of a third image obtained based on a text input.

Referring to FIG. 9B, a state 965 may be or correspond to a state in which a second image 603 is displayed. For example, the at least one processor 210 may display a text input field 970 via the display 230. For example, the text input field 970 may be displayed simultaneously with the second image 603. For example, the at least one processor 210 may receive a text input via the text input field 970. For example, the text input may be or correspond to an input for changing an object 605 in the second image 603.

For example, the text input may be received via a virtual keyboard. For example, the virtual keyboard may be displayed via the display 230 based on a touch input having a contact point on the text input field 970. For example, the text input may be received via an external electronic device (e.g., a keyboard) connected to the electronic device 200. For example, the text input may include a voice input (or speech input) received via a microphone of the electronic device 200. However, it is not limited thereto.

For example, based on the text input, the at least one processor 210 may generate a prompt corresponding to the text input. For example, the at least one processor 210 may provide the prompt and the second image 603 to the trained model. For example, the at least one processor 210 may obtain the third image 945 generated by the trained model using the prompt and the second image 603.

The electronic device 200 may transition from the state 965 to a state 975 based on obtaining the third image 945. In the state 975, the at least one processor 210 may display the third image 945 via the display 230. For example, the third image 945 may be or correspond to an image changed from the second image 603 based on the text input received via the text input field 970. For example, the at least one processor 210 may provide the object 950 including representations intended by the user by displaying the third image 945.

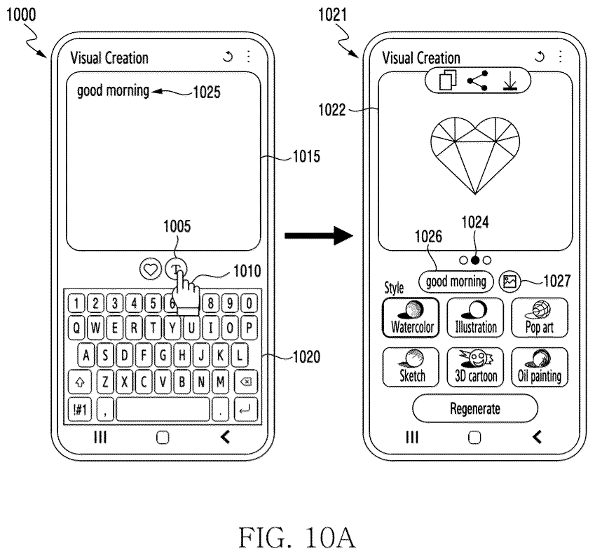

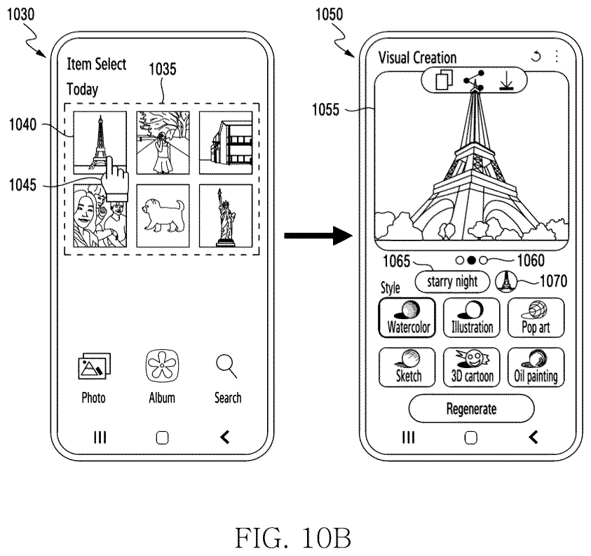

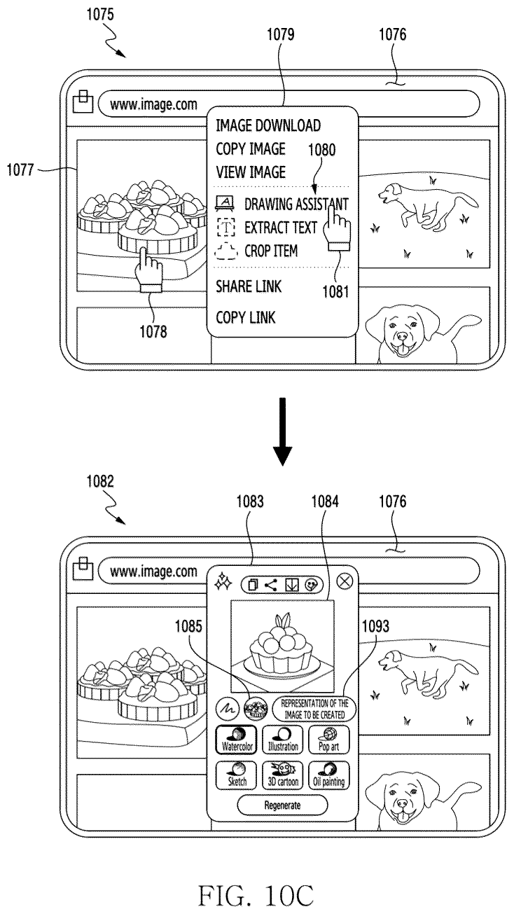

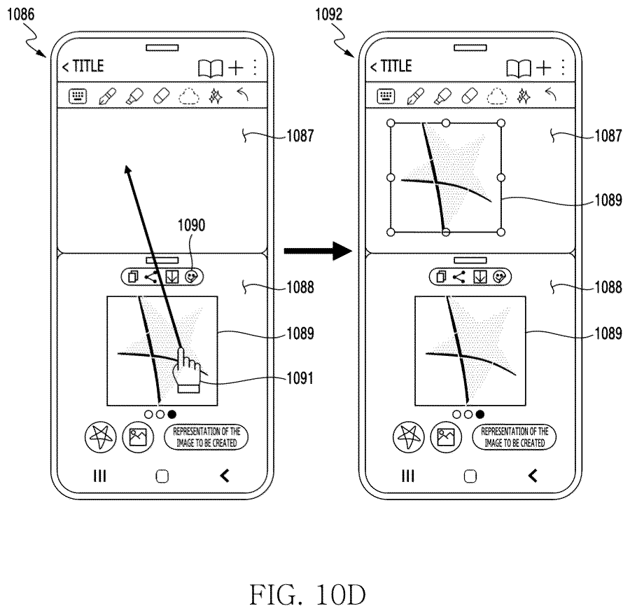

FIGS. 10A, 10B, and 10C illustrate an example of a text input and an image input received with a handwriting input.

Referring to FIG. 10A, a state 1000 may be or correspond to a state in which a text input is received. In the state 1000, at least one processor 210 may display a UI object 1005 for a text input via a display 230. The at least one processor 210 may receive a user input 1010 to the UI object 1005. For example, the user input 1010 may include a touch input having a contact point on the UI object 1005. The user input 1010 may be received via the display 230 (e.g., a touchscreen). For example, the user input 1010 may be received via an external electronic device (e.g., a mouse) connected to an electronic device 200. For example, the user input 1010 may include a voice (or speech) input received via a microphone of the electronic device 200. However, it is not limited thereto.

The at least one processor 210 may display an input field 1015 via the display 230, based on the user input 1010. The at least one processor 210 may receive a text input 1025 via the input field 1015. For example, the text input 1025 may be received via a virtual keyboard 1020 (or a soft keyboard). For example, the text input 1025 may be received via an external electronic device (e.g., a keyboard) connected to the electronic device 200. For example, the text input 1025 may be received via a microphone of the electronic device 200. However, it is not limited thereto. For example, the text input 1025 may be received with a handwriting input. For example, the at least one processor 210 may receive the handwriting input after receiving the text input 1025, or may receive the text input 1025 after receiving the handwriting input.

Based on the text input 1025, the at least one processor 210 may provide a second prompt, which includes information including text (e.g., “good morning”) identified in accordance with the text input 1025 and information on a first image (e.g., the first image 505 of FIG. 5), to a trained model. The at least one processor 210 may obtain a second image 1022 generated by the trained model using the second prompt.

The electronic device 200 may transition from the state 1000 to a state 1021 based on obtaining the second image 1022. In the state 1021, the at least one processor 210 may display, via the display 230, the second image 1022 and UI objects (e.g., the UI objects 635 of FIG. 6A). For example, the at least one processor 210 may further display, via the display 230, an indicator 1024 with the second image 1022. For example, the indicator 1024 may indicate that a scroll input (e.g., a horizontal scroll input) may be received via the second image 1022. Based on the scroll input received on the second image 1022, the at least one processor 210 may display text identified via the text input 1025 or other images generated using the text. For example, the indicator 1024 may represent an image currently being displayed via the display 230, from among the second image 1022, the text, and the other images.

For example, the at least one processor 210 may further display, via the display 230 a UI object 1026 and a UI object 1027. For example, the at least one processor 210 may receive a user input to the UI object 1026 and the UI object 1027. For example, the UI object 1026 may include the text identified via the text input 1025. The at least one processor 210 may display, via the display 230, the text identified via the text input 1025 based on a user input to the UI object 1026. For example, the at least one processor 210 may further receive an image input based on a user input to the UI object 1027. For example, the image input may include a user input selecting one image from among images stored in the electronic device 200. For example, based on the image input, the at least one processor 210 may obtain a third image generated by the trained model using an image identified via the image input, and the second prompt, by providing the image identified via the image input and the second prompt to the trained model.

Referring to FIG. 10B, a state 1030 may be or correspond to a state in which a plurality of images 1035 stored (or stored as associated with a user account) in the electronic device 200 are displayed. In the state 1030, the at least one processor 210 may receive a user input 1045 to at least one image 1040 from among the plurality of images 1035 stored (or stored as associated with a user account) in the electronic device 200. For example, the user input 1045 may include a touch input having a contact point on the at least one image 1040. The user input 1045 may be received via the display 230 (e.g., a touchscreen). For example, the user input 1045 may be received via an external electronic device (e.g., a mouse) connected to the electronic device 200. For example, the user input 1045 may include a voice (or speech) input received via a microphone of the electronic device 200. However, it is not limited thereto.

For example, the at least one processor 210 may display, via the display 230, the at least one image 1040 indicated by the user input 1045, based on receiving the user input 1045. The at least one processor 210 may receive a handwriting input while the at least one image 1040 is displayed. Based on the handwriting input received while the at least one image 1040 is displayed, the at least one processor 210 may obtain a first image including at least one stroke identified in accordance with the handwriting input and the at least one image 1040. The at least one processor 210 may obtain a second image by providing a second prompt including information on the first image to the trained model. The at least one processor 210 may display the second image and UI objects. For example, displaying the second image and the UI objects may refer to the operation 400 to the operation 420 of FIG. 4.

According to another embodiment, the at least one processor 210 may receive the text input 1025 and the user input 1045 to the at least one image 1040. The at least one processor 210 may receive the user input 1045 after receiving the text input 1025, or may receive the text input 1025 after receiving the user input 1045. Based on the text input 1025, the at least one processor 210 may provide a second prompt, which includes information including text identified in accordance with the text input 1025 and information on the at least one image 1040, to the trained model. The at least one processor 210 may obtain a second image 1055 generated by the trained model using the second prompt.

The electronic device 200 may transition from the state 1030 to a state 1050 based on obtaining the second image 1055. In the state 1050, the at least one processor 210 may display the second image 1055 and UI objects via the display 230. For example, displaying the second image and the UI objects may refer to the operation 400 to the operation 420 of FIG. 4.

For example, the at least one processor 210 may further display, via the display 230, an indicator 1060 with the second image 1055. For example, the indicator 1060 may indicate that a scroll input (e.g., a horizontal scroll input) may be received via the second image 1055. Based on the scroll input received on the second image 1055, the at least one processor 210 may display text (e.g., “starry night”) identified via the text input or other images generated using at least one image 1040. For example, the indicator 1060 may represent an image currently being displayed via the display 230, from among the second image 1055, the text, and the other images.

For example, the at least one processor 210 may further display, via the display 230, a UI object 1065 and a UI object 1070. For example, the at least one processor 210 may receive a user input to the UI object 1065 and the UI object 1070. For example, the UI object 1065 may include the text (e.g., “starry night”) identified via the text input. The at least one processor 210 may display, via the display 230, the text (e.g., “starry night”) identified via the text input based on a user input to the UI object 1065. For example, the UI object 1070 may include the at least one image 1040 to which the user input 1045 is received. The at least one processor 210 may display, via the display 230, the at least one image 1040, based on the user input to the UI object 1070.

Referring to FIG. 10C, a state 1075 may be or correspond to a state in which a web application is executed. In the state 1075, the at least one processor 210 may display a web page 1076 via the display 230. For example, the web page 1076 may include a first image 1077. For example, the first image 1077 may be displayed based on a markup language of the web page 1076. For example, the markup language may include hypertext markup language (HTML) and/or extensible markup language (XML).

For example, the at least one processor 210 may receive (or identify) an input 1078 to the first image 1077 in the web page 1076. For example, the input 1078 to the first image 1077 may include a touch input having a contact point on the first image 1077. For example, the input 1078 to the first image 1077 may be referred to as a long press input to the first image 1077. For example, the long press input to the first image 1077 may be or correspond to a touch input having a contact point on the first image 1077 that is maintained for a threshold period of time. For example, the input 1078 to the first image 1077 may include an input received with respect to the first image 1077 via an external electronic device (e.g., a mouse or keyboard) connected to the electronic device 200. For example, the input 1078 to the first image 1077 may include a voice input (or speech input) received via a microphone of the electronic device 200. However, it is not limited thereto.

For example, based on the input 1078 to the first image 1077, the at least one processor 210 may display, via the display 230, a popup window (or floating window) 1079. For example, the popup window 1079 may be displayed as associated with the first image 1077. For example, the popup window 1079 may include a UI object 1080 indicating a change (or an edit) of the first image 1077. For example, the at least one processor 210 may receive (or identify) an input 1081 to the UI object 1080. For example, the input 1081 to the UI object 1080 may be referred to as an input for generating (or obtaining) a second image 1084 using the first image 1077. For example, the input 1081 to the UI object 1080 may include a touch input having a contact point on the UI object 1080. For example, the input 1081 to the UI object 1080 may be received via the display 230 (e.g., a touchscreen). For example, the input 1081 to the UI object 1080 may include an input received with respect to the first image 1077 via an external electronic device (e.g., a mouse or keyboard) connected to the electronic device 200. For example, the input 1078 to the first image 1077 may include a voice input (or speech input) received via a microphone of the electronic device 200. However, it is not limited thereto.

The electronic device 100 may transition from the state 1075 to a state 1082 based on the input 1081. In the state 1082, the at least one processor 210 may execute an application for generating an image (e.g., the second image 1084) using the trained model, based on the input 1081. For example, the at least one processor 210 may display, via the display 230, a screen 1083 of the application for generating an image using the trained model. For example, the screen 1083 may be displayed in a window mode (or picture in picture (PIP)). For example, the screen 1083 may be overlappingly displayed on the web page 1076.

For example, the at least one processor 210 may provide the first image 1077 to the trained model via the screen 1083. For example, the at least one processor 210 may obtain the second image 1084 generated by the trained model using the first image 1077. For example, the at least one processor 210 may display the second image 1084 via the display 230. For example, the second image 1084 may be displayed in the screen 1083 of the application for generating an image using the trained model.

For example, the screen 1083 may include a UI object 1085. For example, the UI object 1085 may represent the first image 1077. The at least one processor 210 may display, via the display 230, images stored in the electronic device 200, based on a user input to the UI object 1085. For example, the at least one processor 210 may further provide at least one image from among the images stored in the electronic device 200 to the trained model. For example, the at least one processor 210 may obtain a third image generated by the trained model further using the at least one image from among the images stored in the electronic device 200.

For example, the screen 1083 may include a text input field 1093. For example, the at least one processor 210 may generate a prompt corresponding to a text input, based on the text input via the text input field 1093. For example, the at least one processor 210 may further provide the prompt to the trained model. For example, the at least one processor 210 may obtain a third image generated further using the prompt.

FIG. 10D illustrates an example of displaying a third image in another application.

Referring to FIG. 10D, a state 1086 may be or correspond to a state in which a first screen 1087 and a second screen 1088 are displayed simultaneously. For example, the first screen 1087 and the second screen 1088 may be displayed in a split view. For example, the first screen 1087 and the second screen 1088 may be displayed simultaneously based on picture in picture (PIP). For example, the first screen 1087 may be overlappingly displayed on the second screen 1088. For example, the second screen 1088 may be overlappingly displayed on the first screen 1087. For example, the first screen 1087 may include a screen of an application for using an image, such as a note application, a messenger application, an electronic document application, or an image editing application. For example, the second screen 1088 may include a screen of an application for generating an image using a trained model.

In the state 1086, the at least one processor 210 may simultaneously display, via the display 230, the first screen 1087 and the second screen 1088. For example, the at least one processor 210 may display the first screen 1087 and the second screen 1088 in a split view. For example, the at least one processor 210 may display an image 1089 generated by the trained model in the second screen 1088. For example, the screen 1088 may include a UI object 1090 for storing the image 1089. For example, the at least one processor 210 may store the image 1089 in the electronic device 200, based on a user input to the UI object 1090. For example, the image 1089 may be stored as a sticker object. For example, the at least one processor 210 may obtain (or store) a sticker object for an object in the image 1089 by cropping the object along its boundary.

For example, the at least one processor 210 may receive (or identify) an input 1091 for displaying the image 1089 in the first screen 1087. For example, the input 1091 may be referred to as a drag input to the image 1089. For example, the input 1091 may be or correspond to a sequence including a touch input having a contact point on the image 1089 (or on the object in the image 1089), a drag input having a contact point moving from the image 1089 (or from an object in the image 1089) to the first screen 1087, and a touch input in which the contact point is released on the first screen 1087. For example, the input 1091 may be received via the display 230 (e.g., a touchscreen).

The electronic device 200 may transition from the state 1086 to a state 1092 based on the input 1091. In the state 1092, the at least one processor 210 may display the image 1089 via the first screen 1087 based on the input 1091. For example, the image 1089 may be displayed in an input field of the first screen 1087. For example, the image 1089 may be displayed as a sticker object representing the object in the image 1089 in the first screen 1087.

For example, based on the input 1091, the at least one processor 210 may bypass a sequence including an operation of storing the image 1089 in the second screen 1088 and an operation of loading the image 1089 in the first screen 1087, by displaying the image 1089 in the first screen 1087. For example, based on the input 1091, the at least one processor 210 may enhance user experience (UX) for the image 1089 by displaying the image 1089 in the first screen 1087.

FIG. 11 is a block diagram illustrating an electronic device 1101 in a network environment 1100 according to various embodiments.

Referring to FIG. 11, the electronic device 1101 in the network environment 1100 may communicate with an electronic device 1102 via a first network 1198 (e.g., a short-range wireless communication network), or at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module(SIM) 1196, or an antenna module 1197. In some embodiments, at least one of the components (e.g., the connecting terminal 1178) may be omitted from the electronic device 1101, or one or more other components may be added in the electronic device 1101. In some embodiments, some of the components (e.g., the sensor module 1176, the camera module 1180, or the antenna module 1197) may be implemented as a single component (e.g., the display module 1160).

The processor 1120 may execute, for example, software (e.g., a program 1140) to control at least one other component (e.g., a hardware or software component) of the electronic device 1101 coupled with the processor 1120, and may perform various data processing or computation. According to an embodiment, as at least part of the data processing or computation, the processor 1120 may store a command or data received from another component (e.g., the sensor module 1176 or the communication module 1190) in volatile memory 1132, process the command or the data stored in the volatile memory 1132, and store resulting data in non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently from, or in conjunction with, the main processor 1121. For example, when the electronic device 1101 includes the main processor 1121 and the auxiliary processor 1123, the auxiliary processor 1123 may be adapted to consume less power than the main processor 1121, or to be specific to a specified function. The auxiliary processor 1123 may be implemented as separate from, or as part of the main processor 1121.

The auxiliary processor 1123 may control at least some of functions or states related to at least one component (e.g., the display module 1160, the sensor module 1176, or the communication module 1190) among the components of the electronic device 1101, instead of the main processor 1121 while the main processor 1121 is in an inactive (e.g., sleep) state, or together with the main processor 1121 while the main processor 1121 is in an active state (e.g., executing an application). According to an embodiment, the auxiliary processor 1123 (e.g., an image signal processor or a communication processor) may be implemented as part of another component (e.g., the camera module 1180 or the communication module 1190) functionally related to the auxiliary processor 1123. According to an embodiment, the auxiliary processor 1123 (e.g., the neural processing unit) may include a hardware structure specified for artificial intelligence model processing. An artificial intelligence model may be generated by machine learning. Such learning may be performed, e.g., by the electronic device 1101 where the artificial intelligence is performed or via a separate server (e.g., the server 1108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 1130 may store various data used by at least one component (e.g., the processor 1120 or the sensor module 1176) of the electronic device 1101. The various data may include, for example, software (e.g., the program 1140) and input data or output data for a command related thereto. The memory 1130 may include the volatile memory 1132 or the non-volatile memory 1134.

The program 1140 may be stored in the memory 1130 as software, and may include, for example, an operating system (OS) 1142, middleware 1144, or an application 1146.

The input module 1150 may receive a command or data to be used by another component (e.g., the processor 1120) of the electronic device 1101, from the outside (e.g., a user) of the electronic device 1101. The input module 1150 may include, for example, a microphone, a mouse, a keyboard, a key (e.g., a button), or a digital pen (e.g., a stylus pen).

The sound output module 1155 may output sound signals to the outside of the electronic device 1101. The sound output module 1155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 1160 may visually provide information to the outside (e.g., a user) of the electronic device 1101. The display module 1160 may include, for example, a display, a hologram device, or a projector and control circuitry to control a corresponding one of the display, hologram device, and projector. According to an embodiment, the display module 1160 may include a touch sensor adapted to detect a touch, or a pressure sensor adapted to measure the intensity of force incurred by the touch.

The audio module 1170 may convert a sound into an electrical signal and vice versa. According to an embodiment, the audio module 1170 may obtain the sound via the input module 1150, or output the sound via the sound output module 1155 or a headphone of an external electronic device (e.g., an electronic device 1102) directly (e.g., wiredly) or wirelessly coupled with the electronic device 1101.

The sensor module 1176 may detect an operational state (e.g., power or temperature) of the electronic device 1101 or an environmental state (e.g., a state of a user) external to the electronic device 1101, and then generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be coupled with the external electronic device (e.g., the electronic device 1102) directly (e.g., wiredly) or wirelessly. According to an embodiment, the interface 1177 may include, for example, a high definition multimedia interface (HDMI), a universal serial bus (USB) interface, a secure digital (SD) card interface, or an audio interface.

A connecting terminal 1178 may include a connector via which the electronic device 1101 may be physically connected with the external electronic device (e.g., the electronic device 1102). According to an embodiment, the connecting terminal 1178 may include, for example, an HDMI connector, a USB connector, an SD card connector, or an audio connector (e.g., a headphone connector).

The haptic module 1179 may convert an electrical signal into a mechanical stimulus (e.g., a vibration or a movement) or electrical stimulus which may be recognized by a user via his tactile sensation or kinesthetic sensation. According to an embodiment, the haptic module 1179 may include, for example, a motor, a piezoelectric element, or an electric stimulator.

The camera module 1180 may capture a still image or moving images. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as at least part of, for example, a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more communication processors that are operable independently from the processor 1120 (e.g., the application processor (AP)) and supports a direct (e.g., wired) communication or a wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 1192 may identify and authenticate the electronic device 1101 in a communication network, such as the first network 1198 or the second network 1199, using subscriber information (e.g., international mobile subscriber identity (IMSI)) stored in the subscriber identification module 1196.

The wireless communication module 1192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., the mmWave band) to achieve, e.g., a high data transmission rate. The wireless communication module 1192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 1192 may support various requirements specified in the electronic device 1101, an external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 1164 dB or less) for implementing mMTC, or U-plane latency (e.g., 0.5 ms or less for each of downlink (DL) and uplink (UL), or a round trip of 11 ms or less) for implementing URLLC.

The antenna module 1197 may transmit or receive a signal or power to or from the outside (e.g., the external electronic device) of the electronic device 1101. According to an embodiment, the antenna module 1197 may include an antenna including a radiating element composed of a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in the communication network, such as the first network 1198 or the second network 1199, may be selected, for example, by the communication module 1190 (e.g., the wireless communication module 1192) from the plurality of antennas. The signal or the power may then be transmitted or received between the communication module 1190 and the external electronic device via the selected at least one antenna. According to an embodiment, another component (e.g., a radio frequency integrated circuit (RFIC)) other than the radiating element may be additionally formed as part of the antenna module 1197.

According to various embodiments, the antenna module 1197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 1101 and the external electronic device 1104 via the server 1108 coupled with the second network 1199. Each of the electronic devices 1102 or 1104 may be a device of a same type as, or a different type, from the electronic device 1101. According to an embodiment, all or some of operations to be executed at the electronic device 1101 may be executed at one or more of the external electronic devices 1102, 1104, or 1108. For example, if the electronic device 1101 should perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 1101. The electronic device 1101 may provide the outcome, with or without further processing of the outcome, as at least part of a reply to the request. To that end, a cloud computing, distributed computing, mobile edge computing (MEC), or client-server computing technology may be used, for example. The electronic device 1101 may provide ultra low-latency services using, e.g., distributed computing or mobile edge computing. In another embodiment, the external electronic device 1104 may include an internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 1140) including one or more instructions that are stored in a storage medium (e.g., internal memory 1136 or external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

FIG. 12 illustrates an example AI system.

Referring to FIG. 12, an AI system 1200 may include an input/output interface 1210, an AI framework 1220, a generative AI model 1230 (or a generative artificial intelligence model), and/or a knowledge repository 1290.

The input/output interface 1210 may receive an input. The input may include data obtained or generated by a user input and/or an electronic device (e.g., the electronic device 200 or the electronic device 1001 described above). The data may include an image, a video, and/or sensor data (e.g., a sensor or a sensor hub (e.g., illuminance data around the electronic device obtained from the auxiliary processor 1123, Posture data (or orientation data) of the electronic device, a temperature inside the electronic device (e.g., a temperature of a display 230 or a temperature of at least one processor 210), size information of the display area of the display 230, and/or an image obtained through an image sensor (e.g., included in a camera module 1180) of the electronic device) generated by at least one processor (e.g., at least one processor 210 or a processor) of the electronic device. The user input may include a natural language, touch data obtained via touch circuitry (e.g., used to identify input from a finger and/or stylus) included in a display panel, an image displayed (and/or to be displayed) on the display panel, and/or a video. As an example without limitation, the user input may be received by the input/output interface 1210 together with context information. The situation information may be or correspond to additional information obtained in connection with the user input. The situation information may be associated with a state (e.g., including a state of the electronic device and/or a state (e.g., a user state) around the electronic device) when the user input is received. For example, the context information may include information on one or more software applications executed within the electronic device when the user input is received. For example, the situation information may include information on a position of the electronic device (or a user's position of the electronic device) when the user input is received. The user input may be integrated with the situation information. As the input, the user input integrated with the situation information may be received via the input/output interface 1210.

The input/output interface 1210 may transmit (or provide) an output. The output may include a result (or result information) generated or obtained by the AI system 1200 based at least in part on the input. A format of the output may vary. For example, the output may include a natural language. For example, the output may include content (e.g., including media content and/or multimedia content). For example, the output may include an action associated with a user of the electronic device. For example, the output may have a format according to a user setting of the electronic device.

The input/output interface 1210 may be or correspond to a user query/response interface 1210.

The AI framework 1220 may be used to obtain information (or data) on the input from the input/output interface 1210 and control one or more components associated with the AI system 1200 using the obtained information.

For example, a prompt design component 1221 in the AI framework 1220 may generate or obtain a prompt for the generative AI model 1230 (e.g., including a large language model (LLM) or a large multimodal model (LMM)), using the obtained information. For example, the prompt design component 1221 may be or correspond to an AI component that uses a learning algorithm and/or a neural network to provide a reinforced prompt over time. For example, the prompt design component 1221 may generate or obtain a prompt by accessing a knowledge component (e.g., the knowledge repository 1290) including user preference data, a prompt library, and/or a prompt example using the obtained information. The generated prompt may be provided to the generative AI model 1230 (e.g., including the LLM or the LMM).

For example, an API/plug-in management component 1222 in the AI framework 1220 may be used to support communication for additional information requested (or caused) in connection with the prompt provided (or to be provided) to the generative AI model 1230. For example, the API/plug-in management component 1222 may be used to generate or establish a channel for communication with various data sources (e.g., the knowledge repository 1290). For example, the API/plug-in management component 1222 may support access to at least some of the data sources. For example, the API/plug-in management component 1222 may be used to request another component (e.g., an application/service component 1280) that performs feedback (or response) according to the prompt. As an example without limitation, information obtained (or generated) via the API/plug-in management component 1222 may be provided to the prompt design component 1221 for generation of a prompt. As an example, without limitation, information obtained (or generated) via the API/plug-in management component 1222 may be provided to the generative AI model 1230.

For example, an improvement component 1223 in the AI framework 1220 may at least partially tune (or adjust)(or change) a result (e.g., content) obtained (or outputted) from the generative AI model 1230. For example, the improvement component 1223 may determine or verify whether the content obtained from the generative AI model 1230 is associated with the input. For example, the improvement component 1223 may determine or verify whether the content obtained from the generative AI model 1230 includes biased content. For example, the improvement component 1223 may determine or verify whether the content obtained from the generative AI model 1230 includes harmful content. For example, the improvement component 1223 may support or assist performing additional processing to improve the content obtained from the generative AI model 1230. For example, the improvement component 1223 may support providing a hint to the user to improve the content.

The generative AI model 1230 may be or correspond to an artificial intelligence neural network that generates feedback in response to a prompt. For example, the feedback is associated with the prompt, but may further include additional data and/or information relative to the prompt. For example, the feedback may include new content in relative to the prompt. For example, the generative AI model 1230 may include a model generating an image and/or a model generating a language. For example, the model generating the image may include a generative adversarial network (GAN) and/or a variational auto encoder (VAE). For example, the model that generating the image may include a diffusion-based generative model (e.g., a transformer VAE). For example, the model generating the language may include CHAT-GPT 3 and/or CHAT-GPT 4. For example, the generative AI model 1230 may include an LMM generating the feedback by recognizing text, image, and/or voice.

As an example without limitation, the AI framework 1220 and/or the generative AI model 1230 may be included in an AI module (e.g., including processing circuitry) in the electronic device 200. For example, the AI module may be operably coupled with at least one processor (e.g., the at least one processor 210 or the processor 1020) of the electronic device 200. For example, the AI module may be operably coupled with display driving circuitry of the electronic device. For example, the AI module may be operably coupled with a sensor hub of the electronic device for one or more sensors in the electronic device.

The technical problems to be achieved in the present disclosure are not limited to those described above, and other technical problems not mentioned herein will be clearly understood by those having ordinary knowledge in the art to which the present disclosure belongs.

An electronic device (e.g., the electronic device 200 of FIG. 2) as described above may include at least one processor (e.g., the at least one processor 210 of FIG. 2) including processing circuitry, a display (e.g., the display 230 of FIG. 2), and memory (e.g., the memory 220 of FIG. 2) comprising one or more storage media storing one or more programs configured to be executed by the at least one processor individually or collectively. The one or more programs may include instructions to cause the electronic device to identify an input to obtain a second image (e.g., the second image 603 of FIG. 6A) using a first image (e.g., the first image 505 of FIG. 5). The one or more programs may include instructions to cause the electronic device to provide, based on the input, the first image to a trained model. The one or more programs may include instructions to cause the electronic device to obtain information on the first image generated by the trained model using the first image. The one or more programs may include instructions to cause the electronic device to obtain a keyword included in the information and options with respect to the keyword. The one or more programs may include instructions to cause the electronic device to provide a prompt including the information to the trained model. The one or more programs may include instructions to cause the electronic device to obtain the second image, including a visual object representing the keyword, generated by the trained model using the prompt. The one or more programs may include instructions to cause the electronic device to display, via the display, the second image and user interface (UI) objects (e.g., the UI objects 635 of FIG. 6A) respectively indicating the options. The one or more programs may include instructions to cause the electronic device to receive, from among the UI objects, a user input (e.g., the user input 910 of FIG. 9A) to at least one UI object (e.g., the at least one UI object 905-1 of FIG. 9A). The one or more programs may include instructions to cause the electronic device to display, based on the user input, via the display, a third image (e.g., the third image 945 of FIG. 9A) including another visual object (e.g., the visual object 950 of FIG. 9A) representing the keyword having an option indicated by the at least one UI object.

For example, the input may include a handwriting input received via the display. The first image may include at least one stroke identified in accordance with the handwriting input.

For example, the input may include an input to determine, from among images stored in the electronic device, the first image as an image to be used to obtain the second image.

For example, the one or more programs may include instructions to cause the electronic device to provide, to the trained model, another prompt to request a description of the first image with the first image. The one or more programs may include instructions to cause the electronic device to obtain the information generated by the trained model using the first image and the another prompt.

For example, the one or more programs may include instructions to cause the electronic device to provide, to the trained model, another prompt to request a description of the first image and a keyword included in the description with the first image. The one or more programs may include instructions to cause the electronic device to obtain the information, the keyword included in the information, and the options that are generated by the trained model using the first image and the another prompt.

For example, the one or more programs may include instructions to cause the electronic device to generate, based on the user input, another prompt including the information and other information on the option indicated by the at least one UI object. The one or more programs may include instructions to cause the electronic device to provide the another prompt to the trained model. The one or more programs may include instructions to cause the electronic device to obtain the third image generated by the trained model using the another prompt. The one or more programs may include instructions to cause the electronic device to display, via the display, the third image.

For example, the one or more programs may include instructions to cause the electronic device to provide the first image with the another prompt to the trained model. The one or more programs may include instructions to cause the electronic device to obtain the third image, including the another visual object representing the keyword having the option, generated by the trained model using the first image and the another prompt, and the another visual object has a shape corresponding to the visual object included in the second image. The one or more programs may include instructions to cause the electronic device to display, via the display, the third image.

For example, the one or more programs may include instructions to cause the electronic device to receive another user input for a style of the second image to be generated. The one or more programs may include instructions to cause the electronic device to generate, based on the another user input, the prompt further including other information on the style. The one or more programs may include instructions to cause the electronic device to provide the prompt to the trained model. The one or more programs may include instructions to cause the electronic device to obtain the second image, including the visual object, generated by the trained model using the prompt, and having the style.

For example, the one or more programs may include instructions to cause the electronic device to receive a text input. The one or more programs may include instructions to cause the electronic device to provide, based on the text input, the prompt further including other information on text identified by the text input to the trained model. The one or more programs may include instructions to cause the electronic device to obtain the second image generated by the trained model using the prompt.

For example, the one or more programs may include instructions to cause the electronic device to receive the handwriting input while a fourth image is displayed via the display. The one or more programs may include instructions to cause the electronic device to obtain, based on the handwriting input received while the fourth image is displayed, the first image including the at least one stroke identified in accordance with the handwriting input and the fourth image. The one or more programs may include instructions to cause the electronic device to provide the first image to the trained model.

For example, the trained model may include a large language model (LLM) and a model for generating an image. The one or more programs may include instructions to cause the electronic device to provide the first image to the LLM. The one or more programs may include instructions to cause the electronic device to obtain the information generated by the LLM using the first image. The one or more programs may include instructions to cause the electronic device to obtain the keyword included in the information and the options with respect to the keyword. The one or more programs may include instructions to cause the electronic device to provide the prompt to the model for generating an image. The one or more programs may include instructions to cause the electronic device to obtain the second image generated by the model for generating an image using the prompt.

For example, the one or more programs may include instructions to cause the electronic device to display, via the display, the first image. The one or more programs may include instructions to cause the electronic device to receive another user input for generating the second image while displaying the first image. The one or more programs may include instructions to cause the electronic device to provide, based on the another user input, the first image to the trained model.

For example, the one or more programs may include instructions to cause the electronic device to receive another user input for changing an appearance of the visual object included in the second image while displaying the second image. The one or more programs may include instructions to cause the electronic device to display, based on the another user input, the UI objects.

For example, the one or more programs may include instructions to cause the electronic device to display, via the display, the second image, other information indicating the keyword, and the UI objects. The UI objects may be displayed as associated with the other information.

For example, the other information may be displayed as associated with a portion of the visual object corresponding to the keyword in the second image.

For example, the one or more programs may include instructions to cause the electronic device to receive another user input for the other information. The one or more programs may include instructions to cause the electronic device to display, based on the other user input, via the display, the UI objects, as associated with the other information.

For example, the one or more programs may include instructions to cause the electronic device to display, via the display, the second image, the UI objects, and a text input field. The one or more programs may include instructions to cause the electronic device to receive a text input via the text input field. The one or more programs may include instructions to cause the electronic device to receive the user input on the at least one UI object from among the UI objects. The one or more programs may include instructions to cause the electronic device to display, based on the text input and the user input, via the display, the third image including the another visual object representing the keyword having text corresponding to the text input and the option indicated by the at least one UI object.

For example, the one or more programs may include instructions to cause the electronic device to generate, based on the text input and the user input, another prompt including the text, the information, and other information on the option indicated by the at least one UI object. The one or more programs may include instructions to cause the electronic device to provide the another prompt to the trained model. The one or more programs may include instructions to cause the electronic device to obtain the third image generated by the trained model using the another prompt. The one or more programs may include instructions to cause the electronic device to display, via the display, the third image.

An electronic device as described above may comprise at least one processor comprising processing circuitry, a display, and memory comprising one or more storage media storing one or more programs configured to be executed by the at least one processor individually or collectively. The one or more programs may include instructions to cause the electronic device to receive a text input to obtain a first image. The one or more programs may include instructions to cause the electronic device to obtain a keyword included in text identified in accordance with the text input and options with respect to the keyword. The one or more programs may include instructions to cause the electronic device to provide a prompt including the text to a trained model. The one or more programs may include instructions to cause the electronic device to obtain the first image, including a visual object representing the keyword, generated by the trained model using the prompt. The one or more programs may include instructions to cause the electronic device to display, via the display, the first image and user interface (UI) objects respectively indicating the options. The one or more programs may include instructions to cause the electronic device to receive, from among the UI objects, a user input to at least one UI object. The one or more programs may include instructions to cause the electronic device to display, based on the user input, via the display, a second image including another visual object representing the keyword having an option indicated by the at least one UI object.

For example, the one or more programs may include instructions to cause the electronic device to receive another user input for changing an appearance of the visual object included in the first image while displaying the first image. The one or more programs may include instructions to cause the electronic device to display, based on the another user input, the UI objects.

For example, the one or more programs may include instructions to cause the electronic device to receive another user input for a style of the first image to be generated. The one or more programs may include instructions to cause the electronic device to generate, based on the another user input, the prompt further including information on the style. The one or more programs may include instructions to cause the electronic device to provide the prompt to the trained model. The one or more programs may include instructions to cause the electronic device to obtain the first image, including the visual object, generated by the trained model using the prompt, and having the style.

For example, the one or more programs may include instructions to cause the electronic device to, based on the user input, generate another prompt including the text and information on the option indicated by the at least one UI object. The one or more programs may include instructions to cause the electronic device to provide the another prompt to the trained model. The one or more programs may include instructions to cause the electronic device to obtain the second image generated by the trained model using the another prompt. The one or more programs may include instructions to cause the electronic device to display, via the display, the second image.

A method as described above may be performed in an electronic device comprising display. The method may comprise identifying an input to obtain a second image using a first image. The method may comprise providing, based on the input, the first image to a trained model. The method may comprise obtaining information on the first image generated by the trained model using the first image. The method may comprise obtaining a keyword included in the information and options with respect to the keyword. The method may comprise providing a prompt including the information to the trained model. The method may comprise obtaining the second image, including a visual object representing the keyword, generated by the trained model using the prompt. The method may comprise displaying, via the display, the second image and user interface (UI) objects respectively indicating the options. The method may comprise receiving, from among the UI objects, a user input to at least one UI object. The method may comprise displaying, based on the user input, via the display, a third image including another visual object representing the keyword having an option indicated by the at least one UI object.

For example, the input may include a handwriting input received via the display. The first image may include at least one stroke identified in accordance with the handwriting input.

For example, the input may include an input to determine, from among images stored in the electronic device, the first image as an image to be used to obtain the second image.

For example, the method may comprise providing to the trained model another prompt to request a description of the first image with the first image. The method may comprise obtaining the information generated by the trained model using the first image and the another prompt.

For example, the method may comprise providing to the trained model another prompt to request a description of the first image and a keyword included in the description with the first image. The method may comprise obtaining the information, the keyword included in the information, and the options that are generated by the trained model using the first image and the another prompt.

For example, the method may comprise generating, based on the user input, another prompt including the information and other information on the option indicated by the at least one UI object. The method may comprise providing the another prompt to the trained model. The method may comprise obtaining the third image generated by the trained model using the another prompt. The method may comprise displaying, via the display, the third image.

For example, the method may comprise providing the first image with the another prompt to the trained model. The method may comprise obtaining the third image, including the another visual object representing the keyword having the option, generated by the trained model using the first image and the another prompt, and the another visual object has a shape corresponding to the visual object included in the second image. The method may comprise displaying, via the display, the third image.

For example, the method may comprise receiving another user input for a style of the second image to be generated. The method may comprise generating, based on the another user input, the prompt further including other information on the style. The method may comprise providing the prompt to the trained model. The method may comprise obtaining the second image, including the visual object, generated by the trained model using the prompt, and having the style.

For example, the method may comprise receiving a text input. The method may comprise providing, based on the text input, the prompt further including other information on text identified by the text input to the trained model. The method may comprise obtaining the second image generated by the trained model using the prompt.

For example, the method may comprise receiving the handwriting input while a fourth image is displayed via the display. The method may comprise obtaining, based on the handwriting input received while the fourth image is displayed, the first image including the at least one stroke identified in accordance with the handwriting input and the fourth image. The method may comprise providing the first image to the trained model.

For example, the trained model may include a large language model (LLM) and a model for generating an image. The method may comprise providing the first image to the LLM. The method may comprise obtaining the information generated by the LLM using the first image. The method may comprise obtaining the keyword included in the information and the options with respect to the keyword. The method may comprise providing the prompt to the model for generating an image. The method may comprise obtaining the second image generated by the model for generating an image using the prompt.

For example, the method may comprise displaying, via the display, the first image. The method may comprise receiving another user input for generating the second image while displaying the first image. The method may comprise providing, based on the another user input, the first image to the trained model.

For example, the method may comprise receiving another user input for changing an appearance of the visual object included in the second image while displaying the second image. The method may comprise displaying, based on the another user input, the UI objects.

For example, the method may comprise displaying, via the display, the second image, other information indicating the keyword, and the UI objects. The UI objects may be displayed as associated with the other information.

For example, the other information may be displayed as associated with a portion of the visual object corresponding to the keyword in the second image.

For example, the method may comprise receiving another user input for the other information. The method may comprise displaying, based on the another user input, via the display, the UI objects, as associated with the other information.

For example, the method may comprise displaying, via the display, the second image, the UI objects, and a text input field. The method may comprise receiving a text input via the text input field. The method may comprise receiving the user input on the at least one UI object from among the UI objects. The method may comprise displaying, based on the text input and the user input, via the display, the third image including the another visual object representing the keyword having text corresponding to the text input and the option indicated by the at least one UI object.

For example, the method may comprise generating, based on the text input and the user input, another prompt including the text, the information, and other information on the option indicated by the at least one UI object. The method may comprise providing the another prompt to the trained model. The method may comprise obtaining the third image generated by the trained model using the another prompt. The method may comprise displaying, via the display, the third image.

A method as described above may be performed in an electronic device comprising display. The method may comprise receiving a text input to obtain a first image. The method may comprise obtaining a keyword included in text identified in accordance with the text input and options with respect to the keyword. The method may comprise providing a prompt including the text to the trained model. The method may comprise obtaining the first image, including a visual object representing the keyword, generated by the trained model using the prompt. The method may comprise displaying, via the display, the first image and user interface (UI) objects respectively indicating the options. The method may comprise receiving, from among the UI objects, a user input to at least one UI object. The method may comprise displaying, based on the user input, via the display, a second image including another visual object representing the keyword having an option indicated by the at least one UI object.

For example, the method may comprise receiving another user input for changing an appearance of the visual object included in the first image while displaying the first image. The method may comprise displaying, based on the another user input, the UI objects.

For example, the method may comprise receiving another user input for a style of the first image to be generated. The method may comprise generating, based on the another user input, the prompt further including information on the style. The method may comprise providing the prompt to the trained model. The method may comprise obtaining the first image, including the visual object, generated by the trained model using the prompt, and having the style.

For example, the method may comprise generating, based on the user input, another prompt including the text and information on the option indicated by the at least one UI object. The method may comprise providing the another prompt to the trained model. The method may comprise obtaining the second image generated by the trained model using the another prompt. The method may comprise displaying, via the display, the second image.

A non-transitory computer-readable storage medium as described above may store one or more programs. The one or more programs, when executed by an electronic device having a display, may include instructions to cause the electronic device to identify an input to obtain a second image using a first image. The one or more programs, when executed by the electronic device, may include instructions to cause the electronic device to provide, based on the input, the first image to a trained model. The one or more programs, when executed by the electronic device, may include instructions to cause the electronic device to obtain information on the first image generated by the trained model using the first image. The one or more programs, when executed by the electronic device, may include instructions to cause the electronic device to obtain a keyword included in the information and options with respect to the keyword. The one or more programs, when executed by the electronic device, may include instructions to cause the electronic device to provide a prompt including the information to the trained model. The one or more programs, when executed by the electronic device, may include instructions to cause the electronic device to obtain the second image, including a visual object representing the keyword, generated by the trained model using the prompt. The one or more programs, when executed by the electronic device, may include instructions to cause the electronic device to display, via the display, the second image and user interface (UI) objects respectively indicating the options. The one or more programs, when executed by the electronic device, may include instructions to cause the electronic device to receive, from among the UI objects, a user input to at least one UI object. The one or more programs, when executed by the electronic device, may include instructions to cause the electronic device to display, based on the user input, via the display, a third image including another visual object representing the keyword having an option indicated by the at least one UI object.

For example, the input may include a handwriting input received via the display. The first image may include at least one stroke identified in accordance with the handwriting input.

For example, the input may include an input to determine, from among images stored in the electronic device, the first image as an image to be used to obtain the second image.

For example, the one or more programs, when executed by the electronic device, may include instructions to cause the electronic device to provide to the trained model another prompt to request a description of the first image with the first image. The one or more programs, when executed by the electronic device, may include instructions to cause the electronic device to obtain the information generated by the trained model using the first image and the another prompt.

For example, the one or more programs, when executed by the electronic device, may include instructions to cause the electronic device to provide to the trained model another prompt to request a description of the first image and a keyword included in the description with the first image. The one or more programs, when executed by the electronic device, may include instructions to cause the electronic device to obtain the information, the keyword included in the information, and the options that are generated by the trained model using the first image and the another prompt.

For example, the one or more programs, when executed by the electronic device, may include instructions to cause the electronic device to generate, based on the user input, another prompt including the information and other information on the option indicated by the at least one UI object. The one or more programs, when executed by the electronic device, may include instructions to cause the electronic device to provide the another prompt to the trained model. The one or more programs, when executed by the electronic device, may include instructions to cause the electronic device to obtain the third image generated by the trained model using the another prompt. The one or more programs, when executed by the electronic device, may include instructions to cause the electronic device to display, via the display, the third image.

For example, the one or more programs, when executed by the electronic device, may include instructions to cause the electronic device to provide the first image with the another prompt to the trained model. The one or more programs, when executed by the electronic device, may include instructions to cause the electronic device to obtain the third image, including the another visual object representing the keyword having the option, generated by the trained model using the first image and the another prompt, and the another visual object has a shape corresponding to the visual object included in the second image. The one or more programs, when executed by the electronic device, may include instructions to cause the electronic device to display, via the display, the third image.

For example, the one or more programs, when executed by the electronic device, may include instructions to cause the electronic device to receive another user input for a style of the second image to be generated. The one or more programs, when executed by the electronic device, may include instructions to cause the electronic device to generate, based on the another user input, the prompt further including other information on the style. The one or more programs, when executed by the electronic device, may include instructions to cause the electronic device to provide the prompt to the trained model. The one or more programs, when executed by the electronic device, may include instructions to cause the electronic device to obtain the second image, including the visual object, generated by the trained model using the prompt, and having the style.

For example, the one or more programs, when executed by the electronic device, may include instructions to cause the electronic device to receive a text input. The one or more programs, when executed by the electronic device, may include instructions to cause the electronic device to provide, based on the text input, the prompt further including other information on text identified by the text input to the trained model. The one or more programs, when executed by the electronic device, may include instructions to cause the electronic device to obtain the second image generated by the trained model using the prompt.

For example, the one or more programs, when executed by the electronic device, may include instructions to cause the electronic device to receive the handwriting input while a fourth image is displayed via the display. The one or more programs, when executed by the electronic device, may include instructions to cause the electronic device to obtain, based on the handwriting input received while the fourth image is displayed, the first image including the at least one stroke identified in accordance with the handwriting input and the fourth image. The one or more programs, when executed by the electronic device, may include instructions to cause the electronic device to provide the first image to the trained model.

For example, the trained model may include a large language model (LLM) and a model for generating an image. The one or more programs, when executed by the electronic device, may include instructions to cause the electronic device to provide the first image to the LLM. The one or more programs, when executed by the electronic device, may include instructions to cause the electronic device to obtain the information generated by the LLM using the first image. The one or more programs, when executed by the electronic device, may include instructions to cause the electronic device to obtain the keyword included in the information and the options with respect to the keyword. The one or more programs, when executed by the electronic device, may include instructions to cause the electronic device to provide the prompt to the model for generating an image. The one or more programs, when executed by the electronic device, may include instructions to cause the electronic device to obtain the second image generated by the model for generating an image using the prompt.

For example, the one or more programs, when executed by the electronic device, may include instructions to cause the electronic device to display, via the display, the first image. The one or more programs, when executed by the electronic device, may include instructions to cause the electronic device to receive another user input for generating the second image while displaying the first image. The one or more programs, when executed by the electronic device, may include instructions to cause the electronic device to provide, based on the another user input, the first image to the trained model.

For example, the one or more programs, when executed by the electronic device, may include instructions to cause the electronic device to receive another user input for changing an appearance of the visual object included in the second image while displaying the second image. The one or more programs, when executed by the electronic device, may include instructions to cause the electronic device to display, based on the another user input, the UI objects.

For example, the one or more programs, when executed by the electronic device, may include instructions to cause the electronic device to display, via the display, the second image, other information indicating the keyword, and the UI objects. The UI objects may be displayed as associated with the other information.

For example, the other information may be displayed as associated with a portion of the visual object corresponding to the keyword in the second image.

For example, the one or more programs, when executed by the electronic device, may include instructions to cause the electronic device to receive another user input for the other information. The one or more programs, when executed by the electronic device, may include instructions to cause the electronic device to display, based on the another user input, via the display, the UI objects, as associated with the other information.

For example, the one or more programs, when executed by the electronic device, may include instructions to cause the electronic device to display, via the display, the second image, the UI objects, and a text input field. The one or more programs, when executed by the electronic device, may include instructions to cause the electronic device to receive a text input via the text input field. The one or more programs, when executed by the electronic device, may include instructions to cause the electronic device to receive the user input on the at least one UI object from among the UI objects. The one or more programs, when executed by the electronic device, may include instructions to cause the electronic device to display, based on the text input and the user input, via the display, the third image including the another visual object representing the keyword having text corresponding to the text input and the option indicated by the at least one UI object.

For example, the one or more programs, when executed by the electronic device, may include instructions to cause the electronic device to generate, based on the text input and the user input, another prompt including the text, the information, and other information on the option indicated by the at least one UI object. The one or more programs, when executed by the electronic device, may include instructions to cause the electronic device to provide the another prompt to the trained model. The one or more programs, when executed by the electronic device, may include instructions to cause the electronic device to obtain the third image generated by the trained model using the another prompt. The one or more programs, when executed by the electronic device, may include instructions to cause the electronic device to display, via the display, the third image.

A non-transitory computer-readable storage medium as described above may store one or more programs. The one or more programs, when executed by an electronic device having a display, may include instructions to cause the electronic device to receive a text input to obtain a first image. The one or more programs, when executed by the electronic device, may include instructions to cause the electronic device to obtain a keyword included in text identified in accordance with the text input and options with respect to the keyword. The one or more programs, when executed by the electronic device, may include instructions to cause the electronic device to provide a prompt including the text to the trained model. The one or more programs, when executed by the electronic device, may include instructions to cause the electronic device to obtain the first image, including a visual object representing the keyword, generated by the trained model using the prompt. The one or more programs, when executed by the electronic device, may include instructions to cause the electronic device to display, via the display, the first image and user interface (UI) objects respectively indicating the options. The one or more programs, when executed by the electronic device, may include instructions to cause the electronic device to receive, from among the UI objects, a user input to at least one UI object. The one or more programs, when executed by the electronic device, may include instructions to cause the electronic device to display, based on the user input, via the display, a second image including another visual object representing the keyword having an option indicated by the at least one UI object.

For example, the one or more programs, when executed by the electronic device, may include instructions to cause the electronic device to receive another user input for changing an appearance of the visual object included in the first image while displaying the first image. The one or more programs, when executed by the electronic device, may include instructions to cause the electronic device to display, based on the another user input, the UI objects.

For example, the one or more programs, when executed by the electronic device, may include instructions to cause the electronic device to receive another user input for a style of the first image to be generated. The one or more programs, when executed by the electronic device, may include instructions to cause the electronic device to generate, based on the another user input, the prompt further including information on the style. The one or more programs, when executed by the electronic device, may include instructions to cause the electronic device to provide the prompt to the trained model. The one or more programs, when executed by the electronic device, may include instructions to cause the electronic device to obtain the first image, including the visual object, generated by the trained model using the prompt, and having the style.

For example, the one or more programs, when executed by the electronic device, may include instructions to cause the electronic device to generate, based on the user input, generate another prompt including the text and information on the option indicated by the at least one UI object. The one or more programs, when executed by the electronic device, may include instructions to cause the electronic device to provide the another prompt to the trained model. The one or more programs, when executed by the electronic device, may include instructions to cause the electronic device to obtain the second image generated by the trained model using the another prompt. The one or more programs, when executed by the electronic device, may include instructions to cause the electronic device to display, via the display, the second image.

The effects that can be obtained from the present disclosure are not limited to those described above, and any other effects not mentioned herein will be clearly understood by those having ordinary knowledge in the art to which the present disclosure belongs.

What is claimed is:

1. An electronic device comprising:
at least one processor comprising processing circuitry;
a display; and
memory comprising one or more storage media storing one or more programs, wherein the one or more programs include instructions that, when executed by the at least one processor individually or collectively, cause the electronic device to:
identify an input to obtain a second image using a first image;
based on the input, provide the first image to a trained model;
obtain information on the first image generated by the trained model using the first image;
obtain a keyword included in the information and options with respect to the keyword,
provide a prompt including the information to the trained model;
obtain the second image, including a first visual object representing the keyword, generated by the trained model using the prompt;
display, via the display, the second image and user interface (UI) objects respectively indicating the options;
receive, from among the UI objects, a user input to at least one UI object; and
based on the user input, display, via the display, a third image including a second visual object representing the keyword having an option indicated by the at least one UI object.

2. The electronic device of claim 1, wherein the input comprises a handwriting input received via the display, and
wherein the first image comprises at least one stroke identified in accordance with the handwriting input.

3. The electronic device of claim 1, wherein the input comprises an input to determine, from among images stored in the electronic device, the first image as an image to be used to obtain the second image.

4. The electronic device of claim 1, wherein the instructions, when executed by the at least one processor individually or collectively, cause the electronic device to:
provide, to the trained model, another prompt to request a description of the first image with the first image; and
obtain the information generated by the trained model using the first image and the another prompt.

5. The electronic device of claim 1, wherein the instructions, when executed by the at least one processor individually or collectively, cause the electronic device to:
provide, to the trained model, another prompt to request a description of the first image and a keyword included in the description with the first image; and
obtain the information, the keyword included in the information, and the options that are generated by the trained model using the first image and the another prompt.

6. The electronic device of claim 1, wherein the instructions, when executed by the at least one processor individually or collectively, cause the electronic device to:
based on the user input, generate another prompt comprising the information and other information on the option indicated by the at least one UI object;
provide the another prompt to the trained model;
obtain the third image generated by the trained model using the another prompt; and
display, via the display, the third image.

7. The electronic device of claim 6, wherein the instructions, when executed by the at least one processor individually or collectively, cause the electronic device to:
provide the first image with the another prompt to the trained model;
obtain the third image, including the second visual object representing the keyword having the option, generated by the trained model using the first image and the another prompt, wherein a shape of the second visual object corresponds to a shape of the first visual object included in the second image; and
display, via the display, the third image.

8. The electronic device of claim 1, wherein the instructions, when executed by the at least one processor individually or collectively, cause the electronic device to:
receive another user input for a style of the second image to be generated;
based on the another user input, generate the prompt further comprising other information on the style;
provide the prompt to the trained model; and
obtain the second image generated by the trained model using the prompt, and
wherein the second image comprises the first visual object and has the style.

9. The electronic device of claim 1, wherein the instructions, when executed by the at least one processor individually or collectively, cause the electronic device to:
receive a text input;
based on the text input, provide the prompt further comprising other information on a text identified by the text input to the trained model; and
obtain the second image generated by the trained model using the prompt.

10. The electronic device of claim 1, wherein the instructions, when executed by the at least one processor individually or collectively, cause the electronic device to:
while a fourth image is displayed via the display, receive a handwriting input;
based on the handwriting input received while the fourth image is displayed, obtain the first image comprising at least one stroke identified in accordance with the handwriting input and the fourth image; and
provide the first image to the trained model.

11. The electronic device of claim 1, wherein the trained model comprises a large language model (LLM) and a model for generating an image, and
wherein the instructions, when executed by the at least one processor individually or collectively, cause the electronic device to:
provide the first image to the LLM;
obtain the information generated by the LLM using the first image;
obtain the keyword included in the information and the options with respect to the keyword;
provide the prompt to the model for generating an image; and
obtain the second image generated by the model for generating an image using the prompt.

12. The electronic device of claim 1, wherein the instructions, when executed by the at least one processor individually or collectively, cause the electronic device to:
display, via the display, the first image;
while displaying the first image, receive another user input for generating the second image; and
based on the another user input, provide the first image to the trained model.

13. The electronic device of claim 1, wherein the instructions, when executed by the at least one processor individually or collectively, cause the electronic device to:
while displaying the second image, receive another user input for changing an appearance of the first visual object included in the second image; and
based on the another user input, display the UI objects.

14. The electronic device of claim 1, wherein the instructions, when executed by the at least one processor individually or collectively, cause the electronic device to display, via the display, the second image, other information indicating the keyword, and the UI objects, and
wherein the UI objects are displayed as associated with the other information.

15. The electronic device of claim 1, wherein the instructions, when executed by the at least one processor individually or collectively, cause the electronic device to:
display, via the display, the second image, the UI objects, and a text input field;
receive a text input via the text input field;
receive the user input on the at least one UI object from among the UI objects; and
based on the text input and the user input, display, via the display, the third image comprising the second visual object representing the keyword having text corresponding to the text input and the option indicated by the at least one UI object.

16. The electronic device of claim 15, wherein the instructions, when executed by the at least one processor individually or collectively, cause the electronic device to:
based on the text input and the user input, generate another prompt including the text, the information, and other information on the option indicated by the at least one UI object;
provide the another prompt to the trained model;
obtain the third image generated by the trained model using the another prompt; and
display, via the display, the third image.

17. An electronic device comprising:
at least one processor comprising processing circuitry;
a display; and
memory comprising one or more storage media storing one or more programs, wherein the one or more programs comprise instructions that, when executed by the at least one processor individually or collectively, cause the electronic device to:
receive a text input to obtain a first image;
obtain a keyword included in text identified in accordance with the text input and options with respect to the keyword,
provide a prompt including the text to the trained model;
obtain the first image, including a first visual object representing the keyword, generated by the trained model using the prompt;
display, via the display, the first image and user interface (UI) objects respectively indicating the options;
receive, from among the UI objects, a user input to at least one UI object; and
based on the user input, display, via the display, a second image including a second visual object representing the keyword having an option indicated by the at least one UI object.

18. The electronic device of claim 17, wherein the instructions, when executed by the at least one processor individually or collectively, cause the electronic device to:
while displaying the first image, receive another user input for changing an appearance of the first visual object included in the first image; and
based on the another user input, display the UI objects.

19. The electronic device of claim 17, wherein the instructions, when executed by the at least one processor individually or collectively, cause the electronic device to:
receive another user input for a style of the first image to be generated;
based on the another user input, generate the prompt further comprising information on the style;
provide the prompt to the trained model; and
obtain the first image, including the first visual object, generated by the trained model using the prompt, and having the style.

20. The electronic device of claim 17, wherein the instructions, when executed by the at least one processor individually or collectively, cause the electronic device to:
based on the user input, generate another prompt comprising the text and information on the option indicated by the at least one UI object;
provide the another prompt to the trained model;
obtain the second image generated by the trained model using the another prompt; and
display, via the display, the second image.
